(19) United States
(12) Patent Application Publication
(10) Pub. No.: US 2006/0004612 A1
(43) Pub. Date: Jan. 5, 2006

(54) Systems and methods for configuring and processing insurance information

(76) Inventors: Timothy W. Chewning, Blythewood, SC (US); Karen M. Russell, Columbia, SC (US); Bryan Scott Creel, Columbia, SC (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/883,582

(22) Filed: Jul. 1, 2004

(51) Int. Cl. G06Q 40/00; G06F 17/21

(52) U.S. Cl. 705/4; 715/512

(57) ABSTRACT

Methods and systems are provided for attaching a note to an insurance policy or claim. In some embodiments, an icon next to a part of an insurance policy may indicate whether a note has been attached. In some embodiments, a note may be attached, or a note may be read, by clicking on the corresponding icon next to a component of the policy. In some embodiments, the components of the policy may include policy information and vehicle information. In some embodiments, a main browser page may be displayed for a user and may include a listing of recent policy activity, a “to-do” list, daily news, daily checkpoints, and favorites. Other information and lists may also be provided on the main browser page. In some embodiments, the information and lists on the main browser page, along with a user's profile, may be configured by a user.

### BACKGROUND

1. Field of the Invention

The present invention generally relates to processing insurance policies. In particular, embodiments relate to systems and methods of providing a graphical user interface for processing an insurance policy.

2. Description of Related Art

Insurance companies generally use databases to maintain information on policy holders. As new policy holders are added, or as information on current policy holders change, the information may be entered into the database by insurance agents using remotely located computers. Insurance agents may also fill out forms by hand and submit the forms to a central database to be entered by data entry personnel. This may be time consuming, however, and may be prone to increased errors because data is entered twice (once onto the form and once from the form to the central database).

Furthermore, customers may call an insurance agent requesting specific information about their policy. It may be necessary for insurance agents to have access to information about the policy. While some insurance agents may keep the information in a file at their office, it may be time consuming to look up the file and then find the relevant part of the file each time a question is asked. There may also be a delay in updating physical files, and therefore, the files may not be accurate. In addition, while some computer programs may allow an insurance agent to see information about a policy (e.g., on a local area network), the insurance agent may not have a way of providing additional information to another viewer of the policy that a component of the policy may have special needs. For example, if a component of the policy is in question, an insurance agent may not have a way to indicate the uncertain status of the claim to his supervisor besides calling the supervisor directly. It may also be possible to leave a physical note in the file, but other entities viewing information about the policy on the computer may not know to look in the file for a separate note. In addition, because an insurance claim, policy, or policy application may have several parts, finding a specific part may be time consuming.

### SUMMARY

In some embodiments, configurable screens for presenting insurance information may be used. Insurance information may include, but is not limited to, information for policies, policy applications, and claims (as used herein, “policy” refers to, policies, policy applications, and claims under a policy). In some embodiments, a note attachment icon may be displayed next to part of a policy on an insurance information screen. In some embodiments, the note attachment icon may be modified if a note has been attached to a part of a policy. For example, a note present attachment icon may include two graphical “x”s to show that a note has been attached to a policy information field. In some embodiments, a user may view the attached note by clicking on the note present attachment icon. In some embodiments, the user may click on the note attachment icon to open a window to enter a note. If a note is entered and saved, the corresponding note attachment icon may be modified to indicate a note has been attached. Other types of icons and indicators may also be used to show that a note has been attached. In various embodiments, other icons may be used next to components of the policy to indicate other information about a component of the policy.

In some embodiments, components of the policy may include a policy information panel and vehicle data entry fields. In some embodiments, other information such as location, available actions, available support, help, and resources may be provided from drop down menus. Other ways of displaying this information may also be used. In some embodiments, tips, including information about icons, may be displayed for a user.

In various embodiments, a main browser page may be displayed for a user. In some embodiments, the main browser page may include a listing of recent policy activity, a “to-do” list, daily news, daily checkpoints, and favorites. Other information and lists may also be provided on the main browser page. In some embodiments, the information and lists on the main browser page may be configured by a user. In some embodiments, a user's profile may be edited by selecting an appropriate indicator. In various embodiments, a user's profile may include a user password, policy activity defaults, daily checkpoint categories, favorites, and display options.

### BRIEF DESCRIPTION OF THE DRAWINGS

Advantages of the invention will become apparent upon reading the following detailed description and upon reference to the accompanying drawings in which:

FIG. 1 illustrates a network diagram of a wide area network suitable for implementing various embodiments.

FIG. 2 illustrates a computer system suitable for implementing various embodiments.

FIG. 3 illustrates an insurance policy data entry screen including a note attachment icon, according to an embodiment.

FIG. 4 illustrates a screen for entering policy note text, according to an embodiment.

FIG. 5 illustrates policy data entry fields, according to an embodiment.

FIG. 6 illustrates vehicle data entry fields, according to an embodiment.

FIG. 7 illustrates a program location panel, according to an embodiment.

FIG. 8 illustrates another available actions panel, according to an embodiment.

FIG. 9 illustrates policy details, according to an embodiment.

FIG. 10 illustrates a selection drop down menu, according to an embodiment.

FIG. 11 illustrates a support drop down menu, according to an embodiment.

FIG. 12 illustrates an applicant help panel, according to an embodiment.

FIG. 13 illustrates a resources drop down menu, according to an embodiment.

FIG. 14 illustrates a tips display panel, according to an embodiment.

FIG. 15 illustrates a main browser page, according to an embodiment.

FIG. 16 illustrates a selection drop down menu for a main browser page, according to an embodiment.

FIG. 17 illustrates a policy inquiry index, according to an embodiment.

FIG. 18 illustrates a change password screen, according to an embodiment.

FIG. 19 illustrates policy activity defaults data entry screen, according to an embodiment.

FIG. 20 illustrates a daily checkpoint categories screen, according to an embodiment.

FIG. 21 illustrates a panel for modifying favorites on the main browser page, according to an embodiment.

FIG. 22 illustrates a display selection screen, according to an embodiment.

FIG. 23 illustrates a flowchart for configuring and presenting insurance information, according to an embodiment.

FIG. 24 illustrates a flowchart for displaying information relative to policy component links, according to an embodiment.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Incorporation by Reference

Embodiments described may be associated with insurance policies, claims under those policies, and policy applications. The following applications and patents related to policy processing, are fully incorporated herein by reference as if set forth herein:

U.S. patent application Ser. No. 09/603,307 to Childress et al., entitled “SYSTEM AND METHOD FOR PROCESSING INSURANCE CLAIMS USING A TABLE OF CONTENTS” filed on Jun. 23, 2000;
U.S. patent application Ser. No. 09/603,129 to Jones, entitled “SYSTEM AND METHOD FOR IDENTIFYING CRITICAL FACTORS AFFECTING AN ESTIMATED VALUE INCLUDED IN AN INSURANCE CLAIM CONSULTATION REPORT” filed on Jun. 23, 2000;
U.S. patent application Ser. No. 09/603,662 to Childress, entitled “RELEVANCE CALCULATION FOR A REFERENCE SYSTEM IN AN INSURANCE CLAIMS PROCESSING SYSTEM” filed on Jun. 23, 2000;
U.S. patent application Ser. No. 09/603,308 to Wolfe et al., entitled “SYSTEM AND METHOD FOR EXTERNALIZATION OF FORMULAS FOR ASSESSING DAMAGES” filed on Jun. 23, 2000;
U.S. patent application Ser. No. 09/603,144 to Jones et al., entitled “SYSTEM AND METHOD FOR EXTERNALIZATION OF RULES FOR ASSESSING DAMAGES” filed on Jun. 23, 2000;
U.S. patent application Ser. No. 09/602,687 to Lorenz, entitled “WEB-ENABLED SYSTEM AND METHOD FOR ASSESSING DAMAGES” filed on Jun. 23, 2000;
U.S. patent application Ser. No. 09/603,302 to Childress, entitled “DYNAMIC HELP SYSTEM FOR AN INSURANCE CLAIMS PROCESSING SYSTEM” filed on Jun. 23, 2000;
U.S. patent application Ser. No. 09/602,691 to Childress, entitled “GRAPHICAL USER INTERFACE WITH A HIDE/SHOW FEATURE FOR A REFERENCE SYSTEM IN AN INSURANCE CLAIMS PROCESSING SYSTEM” filed on Jun. 23, 2000;
U.S. patent application Ser. No. 09/603,130 to Lorenz, entitled “RESET BUTTON FOR WEB-ENABLED SYSTEM AND METHOD FOR ASSESSING DAMAGES” filed on Jun. 23, 2000;
U.S. patent application Ser. No. 09/603,303 to Lorenz, entitled “INTERNET-ENABLED SYSTEM AND METHOD FOR ASSESSING DAMAGES” filed on Jun. 23, 2000;
U.S. patent application Ser. No. 09/603,304 to Lorenz, entitled “PRICING MODELS FOR WEB-ENABLED SYSTEM AND METHOD FOR ASSESSING BODILY INJURY GENERAL DAMAGES” filed on Jun. 23, 2000;
U.S. patent application Ser. No. 10/422,632 to Wahlbin, entitled “GRAPHICAL INPUT DISPLAY IN AN INSURANCE PROCESSING SYSTEM” filed on Apr. 24, 2003;
U.S. patent application Ser. No. 10/422,450 to Wahlbin, entitled “METHOD AND SYSTEM FOR DETERMINING MONETARY AMOUNTS IN AN INSURANCE PROCESSING SYSTEM” filed on Apr. 24, 2003;
U.S. patent application Ser. No. 09/675,380 to Weber et al., entitled “BUSINESS PROCESS FRAMEWORK FOR REINSURANCE” filed on Sep. 29, 2000;
U.S. patent application Ser. No. 09/675,379 to Sverdrup-Thygeson et al., entitled “MULTI-DIMENSIONAL CONTRACT FRAMEWORK FOR REINSURANCE” filed on Sep. 29, 2000;
U.S. patent application Ser. No. 09/676,018 to Evenshaug et al., entitled “CONDITION COMPONENT FRAMEWORK FOR REINSURANCE” filed on Sep. 29, 2000;
U.S. patent application Ser. No. 09/527,110 to Linan et al., entitled “USER-EXTENSIBLE COMPONENT ARCHITECTURE FOR LONG-TERM CARE BENEFITS” filed on Mar. 16, 2000;
U.S. patent application Ser. No. 09/527,325 to Linan et al., entitled “USER-EXTENSIBLE COMPONENT ARCHITECTURE FOR DEFINING LONG-TERM CARE PROVIDER NETWORKS” filed on Mar. 16, 2000;
U.S. patent application Ser. No. 09/527,109 to Linan et al., entitled “SYSTEM AND METHOD FOR DEFINING LONG-TERM CARE BENEFITS” filed on Mar. 16, 2000;
U.S. patent application Ser. No. 09/527,324 to Linan et al., entitled “FOUR-TIER ARCHITECTURE FOR A LONG TERM CARE ADMINISTRATION SYSTEM” filed on Mar. 16, 2000;
U.S. patent application Ser. No. 09/429,808 to Marino et al., entitled “CUSTOMER CLAIM MANAGEMENT SYSTEM” filed on Oct. 29, 1999;
U.S. patent application Ser. No. 09/459,260 to Margoscin et al., entitled “BUSINESS OBJECTS INTERFACE TO INSURANCE PROCESSING SYSTEM” filed on Dec. 10, 1999;
U.S. Patent Application Publication No. 2004-0054557 published on Mar. 18, 2004 to Wahlbin et al., entitled “ESTIMATING PREMISES LIABILITY FOR AN ACCIDENT USING A COMPUTER SYSTEM” filed on Sep. 9, 2002;
U.S. Patent Application Publication No. 2004-0054558 published on Mar. 18, 2004 to Wahlbin et al., entitled “COMPUTERIZED METHOD AND SYSTEM FOR DETERMINING CLAIMANT STATUS IN PREMISES LIABILITY FOR AN ACCIDENT” filed on Sep. 9, 2002;
U.S. Patent Application Publication No. 2004-0049409 published on Mar. 11, 2004 to Wahlbin et al., entitled “COMPUTERIZED METHOD AND SYSTEM FOR DETERMINING BREACH OF DUTY IN PREMISES LIABILITY FOR AN ACCIDENT” filed on Sep. 9, 2002;
U.S. Patent Application Publication No. 2004-0054556 published on Mar. 18, 2004 to Wahlbin et al., entitled “COMPUTERIZED METHOD AND SYSTEM FOR DETERMINING CAUSATION IN PREMISES LIABILITY FOR AN ACCIDENT” filed on Sep. 9, 2002;
U.S. Patent Application Publication No. 2004-0054559 published on Mar. 18, 2004 to Wahlbin et al., entitled “COMPUTERIZED METHOD AND SYSTEM FOR DETERMINING THE CONTRIBUTION OF DEFENSES TO PREMISES LIABILITY FOR AN ACCIDENT” filed on Sep. 9, 2002;
U.S. Patent Application Publication No. 2002-0069091 published on Jun. 6, 2002 to Wahlbin et al., entitled “COMPUTERIZED METHOD OF LIABILITY ASSESSMENT FOR A MOTOR VEHICLE ACCIDENT” filed on Oct. 2, 2001;
U.S. Patent Application Publication No. 2002-0082873 published on Jun. 27, 2002 to Wahlbin et al., entitled “COMPUTERIZED METHOD AND SYSTEM OF DETERMINING RIGHT OF WAY AND LIABILITY FOR AN ACCIDENT” filed on Oct. 2, 2001;
U.S. Patent Application Publication No. 2002-0069092 published on Jun. 6, 2002 to Wahlbin et al., entitled “COMPUTERIZED METHOD AND SYSTEM OF ASSESSING AND ADJUSTING LIABILITY FOR AN ACCIDENT” filed on Oct. 2, 2001;
U.S. Patent Application Publication No. 2002-0062234 published on May 23, 2002 to Wahlbin et al., entitled “COMPUTERIZED METHOD AND SYSTEM OF ESTIMATING LIABILITY AND RANGE OF LIABILITY FOR AN ACCIDENT” filed on Oct. 2, 2001;
U.S. Patent Application Publication No. 2002-0055860 published on May 9, 2002 to Wahlbin et al., entitled “COMPUTERIZED METHOD AND SYSTEM OF DETERMINING RIGHT OF WAY IN AN ACCIDENT” filed on Oct. 2, 2001;
U.S. Patent Application Publication No. 2002-0062233 published on May 23, 2002 to Wahlbin et al., entitled “COMPUTERIZED METHOD AND SYSTEM OF ASSESSING LIABILITY FOR AN ACCIDENT USING IMPACT GROUPS” filed on Oct. 2, 2001;
U.S. Patent Application Publication No. 2002-0059097 published on May 16, 2002 to Wahlbin et al., entitled “COMPUTERIZED METHOD AND SYSTEM OF ASSIGNING AN ABSOLUTE LIABILITY VALUE FOR AN ACCIDENT” filed on Oct. 2, 2001;
U.S. Patent Application Publication No. 2002-0087363 published on Jul. 4, 2002 to Wahlbin et al., entitled “COMPUTERIZED METHOD AND SYSTEM OF LIABILITY ASSESSMENT FOR AN ACCIDENT USING ENVIRONMENTAL, VEHICLE, AND DRIVER CONDITIONS AND DRIVER ACTIONS” filed on Oct. 2, 2001;
U.S. Patent Application Publication No. 2002-0091504 published on Jul. 11, 2002 to Wahlbin et al., entitled “COMPUTERIZED METHOD AND SYSTEM FOR ACCUMULATING LIABILITY ESTIMATES” filed on Oct. 2, 2001;
U.S. Patent Application Publication No. 2002-0128881 published on Sep. 12, 2002 to Wahlbin et al., entitled “COMPUTERIZED METHOD AND SYSTEM FOR ADJUSTING LIABILITY ESTIMATES IN AN ACCIDENT LIABILITY ASSESSMENT PROGRAM” filed on Oct. 2, 2001;
U.S. Patent Application Publication No. 2002-0062232 published on Sep. 12, 2002 to Wahlbin et al., entitled “COMPUTERIZED METHOD AND SYSTEM FOR ADJUSTING LIABILITY ESTIMATION FACTORS IN AN ACCIDENT LIABILITY ASSESSMENT PROGRAM” filed on Oct. 2, 2001;
U.S. Patent Application Publication No. 2002-0062235 published on May 23, 2002 to Wahlbin et al., entitled “COMPUTERIZED METHOD AND SYSTEM FOR PROVIDING CLAIMS DATA TO AN ACCIDENT LIABILITY ASSESSMENT PROGRAM” filed on Oct. 2, 2001;
U.S. Patent Application Publication No. 2002-0059084 published on May 16, 2002 to Wahlbin et al., entitled “COMPUTERIZED METHOD AND SYSTEM OF DISPLAYING AN ACCIDENT TYPE” filed on Oct. 2, 2001;
U.S. Patent Application Publication No. 2002-0059086 published on May 16, 2002 to Wahlbin et al., entitled “COMPUTERIZED METHOD AND SYSTEM OF DISPLAYING A ROADWAY CONFIGURATION RELATING TO AN ACCIDENT” filed on Oct. 2, 2001;
U.S. Patent Application Publication No. 2002-0059087 published on May 16, 2002 to Wahlbin et al., entitled “COMPUTERIZED METHOD AND SYSTEM OF DISPLAYING AN IMPACT POINT RELATING TO AN ACCIDENT” filed on Oct. 2, 2001;
U.S. Patent Application Publication No. 2002-0059083 published on May 16, 2002 to Wahlbin et al., entitled “COMPUTERIZED METHOD AND SYSTEM OF DETERMINING INCONSISTENCIES IN WITNESS STATEMENTS RELATING TO AN ACCIDENT” filed on Oct. 2, 2001;
U.S. Patent Application Publication No. 2002-0049619 published on Apr. 25, 2002 to Wahlbin et al., entitled “COMPUTERIZED METHOD AND SYSTEM OF IDENTIFYING A CREDIBLE WITNESS STATEMENT RELATING TO AN ACCIDENT” filed on Oct. 2, 2001;
U.S. Patent Application Publication No. 2002-0059085 published on May 16, 2002 to Wahlbin et al., entitled “COMPUTERIZED METHOD AND SYSTEM OF DETERMINING A CREDIBLE REAL SET OF CHARACTERISTICS FOR AN ACCIDENT” filed on Oct. 2, 2001;
U.S. patent application Ser. No. 10/306,864 to Wahlbin et al., entitled “COMPUTERIZED METHOD AND SYSTEM FOR ESTIMATING LIABILITY FOR AN ACCIDENT FROM AN INVESTIGATION OF THE ACCIDENT” filed on Nov. 27, 2002;
U.S. patent application Ser. No. 10/306,873 to Wahlbin et al., entitled “COMPUTERIZED METHOD AND SYSTEM FOR ESTIMATING LIABILITY FOR AN ACCIDENT USING DYNAMIC GENERATION OF QUESTIONS” filed on Nov. 27, 2002;
U.S. patent application Ser. No. 10/306,909 to Wahlbin et al., entitled “COMPUTERIZED METHOD AND SYSTEM FOR ESTIMATING AN EFFECT ON LIABILITY OF THE SPEED OF VEHICLES IN AN ACCIDENT AND TIME AND DISTANCE TRAVELED BY THE VEHICLES” filed on Nov. 27, 2002;
U.S. patent application Ser. No. 10/306,623 to Wahlbin et al., entitled “COMPUTERIZED METHOD AND SYSTEM FOR ESTIMATING AN EFFECT ON LIABILITY USING A COMPARISON OF THE ACTUAL SPEED OF VEHICLES IN AN ACCIDENT AND TIME AND DISTANCE TRAVELED BY THE VEHICLES IN A MERGING VEHICLE ACCIDENT” filed on Nov. 27, 2002;
U.S. patent application Ser. No. 10/306,803 to Wahlbin et al., entitled “COMPUTERIZED METHOD AND SYSTEM FOR ESTIMATING AN EFFECT ON LIABILITY USING A COMPARISON OF THE ACTUAL SPEED OF VEHICLES WITH A SPECIFIED SPEED” filed on Nov. 27, 2002;
U.S. patent application Ser. No. 10/306,908 to Wahlbin et al., entitled “COMPUTERIZED METHOD AND SYSTEM FOR ESTIMATING AN EFFECT ON LIABILITY BASED ON THE STOPPING DISTANCE OF VEHICLES” filed on Nov. 27, 2002;
U.S. patent application Ser. No. 10/306,804 to Wahibin et al., entitled “COMPUTERIZED METHOD AND SYSTEM FOR ESTIMATING AN EFFECT ON LIABILITY USING CLAIM DATA ACCESSED FROM CLAIM REPORTING SOFTWARE” filed on Nov. 27, 2002;
U.S. patent application Ser. No. 10/306,866 to Wahlbin et al., entitled “COMPUTERIZED METHOD AND SYSTEM FOR CREATING PRE-CONFIGURED CLAIM REPORTS INCLUDING LIABILITY IN AN ACCIDENT ESTIMATED USING A COMPUTER SYSTEM” filed on Nov. 27, 2002;
U.S. patent application Ser. No. 10/306,858 to Wahlbin et al., entitled “COMPUTERIZED METHOD AND SYSTEM FOR ESTIMATING LIABILITY USING RECORDED VEHICLE DATA” filed on Nov. 27, 2002;
U.S. patent application Ser. No. 10/306,628 to Wahlbin et al., entitled “COMPUTERIZED METHOD AND SYSTEM FOR ESTIMATING MONETARY DAMAGES DUE TO INJURIES IN AN ACCIDENT FROM LIABILITY ESTIMATED USING A COMPUTER SYSTEM” filed on Nov. 27, 2002;
U.S. patent application Ser. No. 10/790,632 to Woods et al., entitled “GRAPHICAL INJURY SELECTION” filed on Mar. 1, 2004;
U.S. patent application Ser. No. 10/702,088 to Madill, Jr. et al., entitled “SYSTEMS AND METHODS FOR ASSESSING THE POTENTIAL FOR FRAUD IN BUSINESS TRANSACTIONS” filed on Nov. 5, 2003; and
U.S. patent application Ser. No. 10/702,094 to Madill, Jr. et al., entitled “FRAUD POTENTIAL INDICATOR GRAPHICAL INTERFACE” filed on Nov. 5, 2003.
U.S. patent application Ser. No. 10/786,572 to Osborne, entitled “SYSTEMS AND METHODS FOR PRINTING AN INSURANCE DOCUMENT” filed on Feb. 25, 2004
U.S. patent application Ser. No. 10/838,159 to Van Hutten et al., entitled “SYSTEM AND METHOD FOR CAPTURING AN IMAGE” filed on May 3, 2004

In addition, the embodiments described below may also be applied to financial transactions. The following applications and patents related to financial transactions, are fully incorporated herein by reference as if set forth herein:
U.S. patent application Ser. No. 09/603,306 to Wolfe, entitled “SYSTEM AND METHOD FOR DISPLAYING MESSAGES USING A MESSAGES TABLE Jun. 23, 2000;
U.S. Patent Application Publication No. 2004-0088196 published on May 6, 2004 to Childress et al., entitled “GRAPHICAL DISPLAY OF BUSINESS RULES” filed on Oct. 31, 2002;
U.S. Patent Application Publication No. 2004-0088195 published on May 6, 2004 to Childress et al., entitled “METHOD OF MODIFYING A BUSINESS RULE” filed on Oct. 31, 2002;
U.S. Patent Application Publication No. 2004-0088198 published on May 6, 2004 to Childress et al., entitled “METHOD OF MODIFYING A BUSINESS RULE WHILE TRACKING THE MODIFICATIONS” filed on Oct. 31, 2002;
U.S. Patent Application Publication No. 2004-0088199 published on May 6, 2004 to Childress et al., entitled “METHOD OF FORMING A BUSINESS RULE” filed on Oct. 31, 2002;
U.S. Patent Application Publication No. 2004-0088197 published on May 6, 2004 to Childress et al., entitled “METHOD OF GENERATING A GRAPHICAL DISPLAY OF A BUSINESS RULE WITH A TRANSLATION” filed on Oct. 31, 2002;
U.S. Patent Application Publication No. 2004-0085357 published on May 6, 2004 to Childress et al., entitled “METHOD OF GENERATING A GRAPHICAL DISPLAY OF A BUSINESS RULE AND ASSOCIATED BUSINESS RULE ELEMENTS” filed on Oct. 31, 2002;
U.S. patent application Ser. No. 10/790,626 to Lorenz, entitled “SYSTEMS AND METHODS FOR USING DATA STRUCTURE LANGUAGE IN WEB SERVICES” filed on Mar. 1, 2004;
U.S. Pat. No. 5,909,683 to Miginiac et al., entitled “RELATIONAL DATA BASE CONTROL SYSTEM USING OBJECT-ORIENTED ACCESS LOGIC TO LIMIT THE DATA BASE ACCESS COUNT, AND METHOD THEREFOR” filed on Dec. 10, 1996;
U.S. Pat. No. 6,446,086 to Bartlett et al., entitled “SYSTEM AND METHOD FOR LOGGING TRANSACTION RECORDS IN A COMPUTER SYSTEM” filed on Jun. 30, 1999;
U.S. patent application Ser. No. 09/365,066 to Frutuoso et al., entitled “EVENT-TRIGGERED TRANSACTION PROCESSING FOR ELECTRONIC DATA INTERCHANGE” filed on Jul. 30, 1999;
U.S. patent application Ser. No. 09/629,834 to Frutuoso et al., entitled “EVENT-TRIGGERED TRANSACTION PROCESSING FOR ELECTRONIC DATA INTERCHANGE” filed on Jul. 31, 2000;
U.S. patent application Ser. No. 09/345,698 to Bartlett et al., entitled “SYSTEM AND METHOD FOR SYNCHRONIZING COPIES OF DATA IN A COMPUTER SYSTEM” filed on Jun. 30, 1999;
U.S. patent application Ser. No. 09/699,036 to Bobbitt et al., entitled “CONFIGURING PROCESSING RELATIONSHIPS AMONG ENTITIES OF AN ORGANIZATION” filed on Oct. 27, 2000;
U.S. patent application Ser. No. 09/699,015 to Bobbitt et al., entitled “BUSINESS TRANSACTION PROCESSING SYSTEMS AND METHOD” filed on Oct. 27, 2000;
U.S. patent application Ser. No. 09/699,054 to Bobbitt et al., entitled “CONFIGURING SYSTEM FOR GENERATING BUSINESS TRANSACTION REPORTS USING PROCESSING RELATIONSHIPS AMONG ENTITIES OF AN ORGANIZATION” filed on Oct. 27, 2000;
U.S. patent application Ser. No. 09/699,038 to Shaw, entitled “SMART TRIGGER FOR USE IN PROCESSING BUSINESS TRANSACTIONS” filed on Oct. 27, 2000;
U.S. patent application Ser. No. 09/699,021 to Bobbitt et al., entitled “CONFIGURING DYNAMIC DATABASE PACKAGESET SWITCHING FOR USE IN PROCESSING BUSINESS TRANSACTIONS” filed on Oct. 27, 2000;
U.S. patent application Ser. No. 09/699,058 to Doughty et al., entitled “PROCESSING BUSINESS TRANSACTIONS USING DYNAMIC DATABASE PACKAGESET SWITCHING” filed on Oct. 27, 2000;
U.S. patent application Ser. No. 09/699,056 to Doughty, entitled “PROCESSING BUSINESS DATA USING USER-CONFIGURED KEYS” filed on Oct. 27, 2000;
U.S. patent application Ser. No. 09/699,037 to Doughty, entitled “CONFIGURING KEYS FOR USE IN PROCESSING BUSINESS DATA” filed on Oct. 27, 2000;
U.S. patent application Ser. No. 09/386,862 to Baker et al., entitled “Q&A SESSION USER INTERFACE FOR CAPTURING INFORMATION DURING CUSTOMER INTERVIEW” filed on Aug. 31, 1999;
U.S. patent application Ser. No. 09/386,858 to Baker et al., entitled “PRODUCT RECOMMENDATION TOOL FOR EVALUATING RESPONSES TO CUSTOMER QUESTIONS” filed on Aug. 31, 1999;
U.S. patent application Ser. No. 09/386,860 to Baker et al., entitled “SPECIALIZED SYSTEM PARAMETER SERVICES FOR CONTROLLING AND DEFINING A LINE OF BUSINESS” filed on Aug. 31, 1999;
U.S. patent application Ser. No. 09/648,929 to Bierenbaum, entitled “PRODUCTION BUILDER FOR COMPILING OBJECTS GENERATED BY A BUSINESS MODELER” filed on Aug. 25, 2000;
U.S. patent application Ser. No. 09/648,247 to Bierenbaum, entitled “FLOW DESIGNER FOR ESTABLISHING AND MAINTAINING ASSIGNMENT AND STRATEGY PROCESS MAPS” filed on Aug. 25, 2000;
U.S. patent application Ser. No. 09/648,921 to Bierenbaum, entitled “BUSINESS MODELER FOR DEFINING AND ORGANIZING FINANCIAL SERVICE PROCESS FLOW” filed on Aug. 25, 2000;
U.S. patent application Ser. No. 09/648,246 to Bierenbaum, entitled “SYSTEM AND METHOD FOR DIRECTING AND MANAGING FINANCIAL SERVICE ORGANIZATION TRANSACTIONS” filed on Aug. 25, 2000;
U.S. patent application Ser. No. 09/648,655 to Bierenbaum, entitled “EXTERNAL INTERFACE FOR REQUESTING DATA FROM REMOTE SYSTEMS IN A GENERIC FASHION” filed on Aug. 25, 2000;
U.S. Patent Application Publication No. 2003-0158759 published on Aug. 21, 2003 to Kannenberg, entitled “METHOD OF MODIFYING SOFTWARE BY DEFINING BUSINESS RULES” filed on Jan. 7, 2003;
U.S. Patent Application Publication No. 2003-0158760 published on Aug. 21, 2003 to Kannenberg, entitled “SYSTEM FOR MODIFYING SOFTWARE USING REUSEABLE SOFTWARE COMPONENTS” filed on Jan. 7, 2003;
U.S. Patent Application Publication No. 2003-0172367 published on Sep. 11, 2003 to Kannenberg, entitled “METHOD OF MODIFYING SOFTWARE VIA A NETWORK” filed on Jan. 7, 2003;
U.S. patent application Ser. No. 10/714,523 to Houle et al., entitled “SYSTEMS AND METHODS FOR ASSESSING DOCUMENTS USING ANALYSIS OF MACHINE-PRINTED WRITING AND PRE-PRINTED INFORMATION” filed on Nov. 14, 2003;
U.S. patent application Ser. No. 10/735,280 to Houle et al., entitled “SYSTEMS AND METHODS FOR HANDWRITING ANALYSIS IN DOCUMENTS” filed on Dec. 12, 2003;
U.S. patent application Ser. No. 10/734,738 to Houle et al., entitled “SYSTEMS AND METHODS FOR CAPTURING HANDWRITTEN INFORMATION USING HANDWRITING ANALYSIS” filed on Dec. 12, 2003;
U.S. patent application Ser. No. 10/741,156 to Houle et al., entitled “SYSTEMS AND METHODS FOR ASSESSING A DOCUMENT USING CROSS-CORRELATION ANALYSIS” filed on Dec. 19, 2003;
U.S. patent application Ser. No. 10/741,157 to Houle et al., entitled “SYSTEMS AND METHODS FOR IDENTIFYING A DOCUMENT WITH FORGED INFORMATION” filed on Dec. 19, 2003;

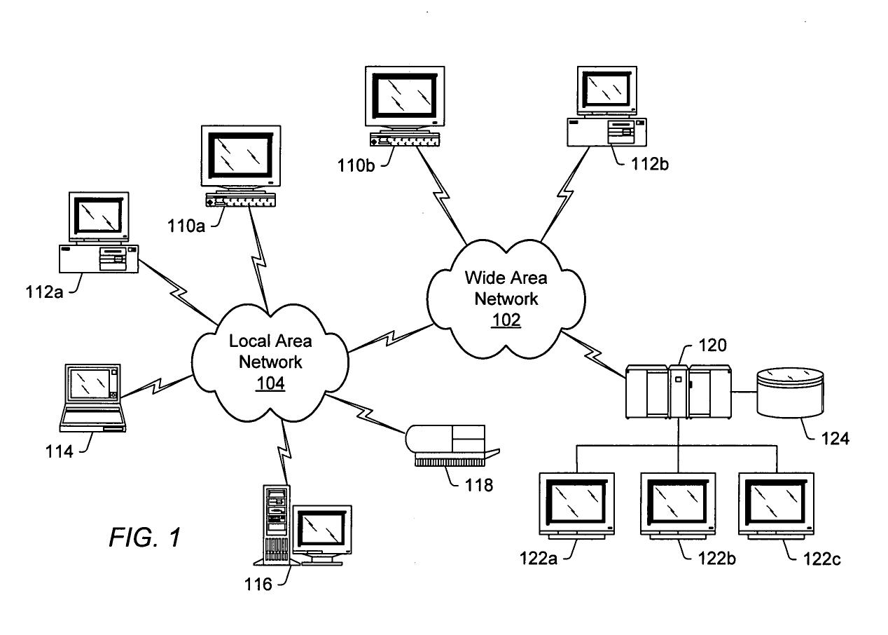

FIG. 1 illustrates an embodiment of a wide area network (“WAN”). WAN 102 may be a network that spans a relatively large geographical area. The Internet is an example of WAN 102. WAN 102 typically includes a plurality of computer systems that may be interconnected through one or more networks. Although one particular configuration is shown in FIG. 1, WAN 102 may include a variety of heterogeneous computer systems and networks that may be interconnected in a variety of ways and that may run a variety of software applications.

One or more local area networks (“LANs”) 104 may be coupled to WAN 102. LAN 104 may be a network that spans a relatively small area. Typically, LAN 104 may be confined to a single building or group of buildings. Each node (i.e., individual computer system or device) on LAN 104 may have its own CPU with which it may execute programs, and each node may also be able to access data and devices anywhere on LAN 104. LAN 104, thus, may allow many users to share devices (e.g., printers) and data stored on file servers. LAN 104 may be characterized by a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, and/or radio waves).

Each LAN 104 may include a plurality of interconnected computer systems and optionally one or more other devices such as one or more workstations 110a, one or more personal computers 112a, one or more laptop or notebook computer systems 114, one or more server computer systems 116, and one or more network printers 118. As illustrated in FIG. 1, an example LAN 104 may include one of each computer systems 110a, 112a, 114, and 116, and one printer 118. LAN 104 may be coupled to other computer systems and/or other devices and/or other LANs 104 through WAN 102.

One or more mainframe computer systems 120 may be coupled to WAN 102. As shown, mainframe 120 may be coupled to a storage device or file server 124 and mainframe terminals 122a, 122b, and 122c. Mainframe terminals 122a, 122b, and 122c may access data stored in the storage device or file server 124 coupled to or included in mainframe computer system 120.

WAN 102 may also include computer systems connected to WAN 102 individually and not through LAN 104 for purposes of example, workstation 110b and personal computer 112b. For example, WAN 102 may include computer systems that may be geographically remote and connected to each other through the Internet.

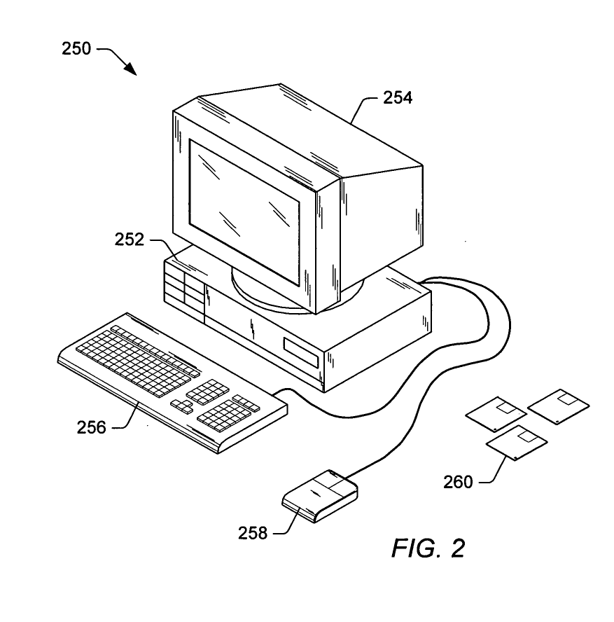

FIG. 2 illustrates an embodiment of computer system 250 that may be suitable for implementing various embodiments of a system and method for configuring and presenting insurance information. Each computer system 250 typically includes components such as CPU 252 with an associated memory medium such as floppy disks 260. The memory medium may store program instructions for computer programs. The program instructions may be executable by CPU 252. Computer system 250 may further include a display device such as monitor 254, an alphanumeric input device such as keyboard 256, and a directional input device such as mouse 258. Computer system 250 may be operable to execute the computer programs to implement computer-implemented systems and methods for configuring and presenting insurance information.

Computer system 250 may include a memory medium on which computer programs according to various embodiments may be stored. The term “memory medium” is intended to include an installation medium, e.g., a CD-ROM or floppy disks 260, a computer system memory such as DRAM, SRAM, EDO RAM, Rambus RAM, etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. Computer system 250 may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to configure and present insurance information. The software program(s) may be implemented in various ways, including, but not limited to, procedure-based techniques, component-based techniques, and/or object-oriented techniques, among others. For example, the software programs may be implemented using ActiveX controls, C++ objects, C#, JavaBeans, Microsoft Foundation Classes (“MFC”), Visual Basic Net, J2EE, Microsoft .Net, and browser-based applications (e.g., Java applets), traditional programs, or other technologies or methodologies, as desired. A CPU such as host CPU 252 executing code and data from the memory medium may include a means for creating and executing the software program or programs according to the embodiments described herein.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

Various embodiments include configuring and presenting insurance information. While various embodiments for configuring and presenting insurance information are discussed below with respect to insurance claims, it is to be understood that these embodiments may also be applied to other industries. As used herein a “claim” may refer to a demand for compensation for a loss, such as, but not limited to, medical treatment due to bodily injury, death of an insured, property damage, etc. In addition, as used herein, “policy” refers to, among others, policies, policy applications, and claims under a policy.

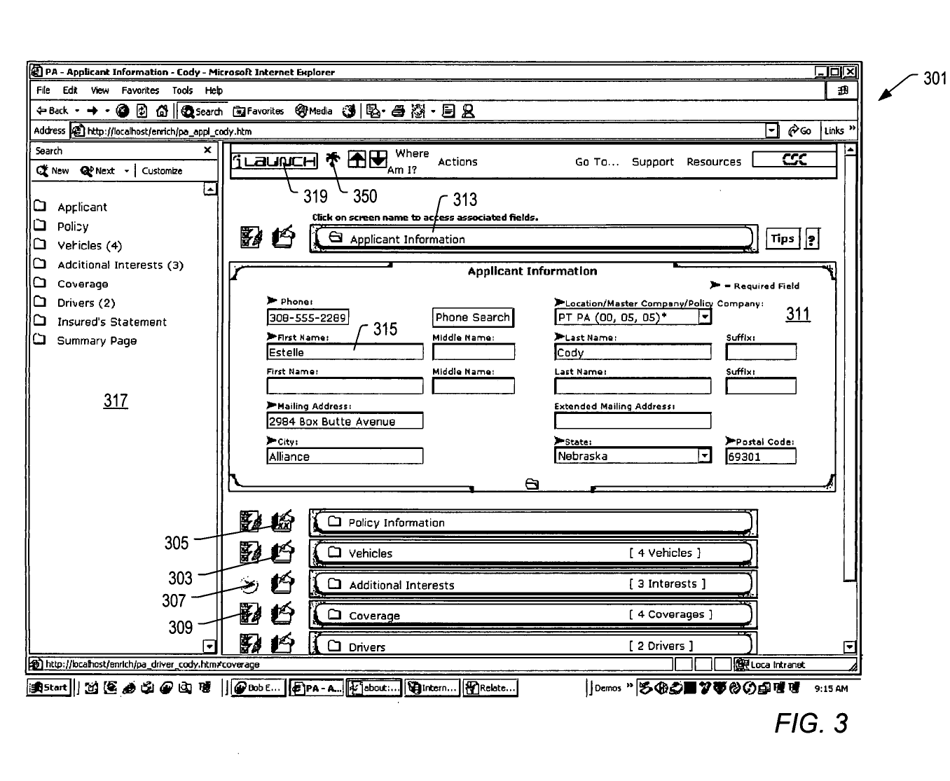

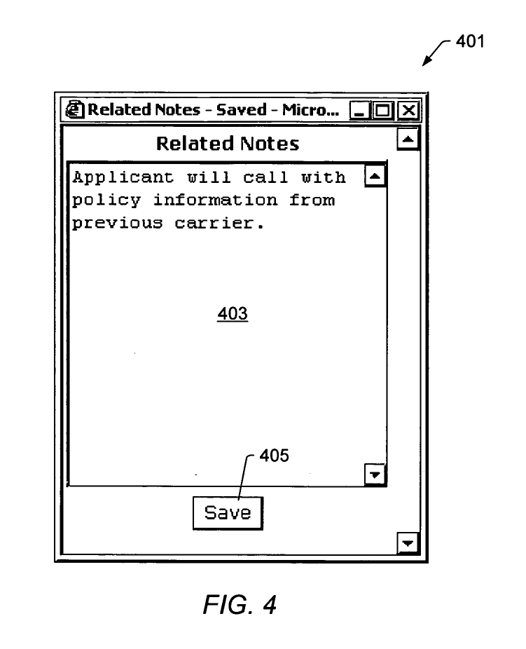

FIG. 3 illustrates an embodiment of an insurance policy data entry screen including a note attachment icon. In various embodiments, components of an insurance policy, insurance claim, and/or insurance policy application may be represented by icons or in menus (e.g., applicant information, policy information, vehicle information, interests, coverage, drivers, and statements). Similar formats, icons, links, etc. described below may also be used in financial transaction processing. In various embodiments, by selecting an insurance policy component link (e.g., by clicking on an icon or on a menu of policy component links using a mouse pointer), a data entry panel may be displayed for that particular component of the insurance policy. In some embodiments, note attachment icon 303 may be displayed next to a component of a policy on insurance information screen 301. In some embodiments, note attachment icon 303 may be modified if a note has been attached to a component of a policy. For example, note present attachment icon 305 includes two graphical “x”s to show that a note has been attached to a policy information field of the policy component. In some embodiments, a user may view the attached note by clicking on note present attachment icon 305 to view the note attached to the policy information field. In some embodiments, the user may click on note attachment icon 303 to open window 401 (see FIG. 4) to enter note 403. In some embodiments, the note may contain information about missing data, questionable data, actions that need to be taken, comments from the insurance agent, comments from the insured, and other information. In some embodiments, note 403 may contain, information that is not typically included with every insurance policy. In some embodiments, the note may be saved using save button 405. In various embodiments, if note 403 is entered and saved, the corresponding note attachment icon (e.g., note attachment icon 303) may be modified to indicate note 403 has been attached. Other types of icons and indicators may also be used to show that a note has been attached.

In some embodiments, a checkbox (not shown) next to the policy part may be used to show if a note has been attached (e.g., empty if no note is attached and checked if a note has been attached). In an embodiment, clicking on an empty checkbox may bring up note window 401. In some embodiments, an icon may be shown next to a component of the policy only if a note has been entered for that component of the policy (e.g., no icon may indicate that a note has not been attached). Other ways of entering a note may also be used. For example, instead of a separate window 401, a drop down text box (not shown) may be used. In an embodiment, a separate panel (not shown) on the display may be used for entering notes. In some embodiments, a note file, prepared using a separate program (e.g., a note written in a word processing program), may be attached to the policy. In various embodiments, access to note 403 may be password protected (e.g., a user may be required to enter their password when they try to open the note, create a note, or modify a note).

In various embodiments, other icons may be used next to parts of an insurance policy to indicate other information about a part of the insurance policy. For example, no required fields icon 307 may be used to indicate that there are no fields on the corresponding component of the policy that required data entry. In some embodiments, data field panel 311 may be opened for a component of the policy by clicking on a button for the respective component of the policy (e.g., applicant information button 313). In some embodiments, components of the policy may also be listed in a separate navigation panel 317 (e.g., policy components such as applicant, policy, vehicles, additional interests, coverage, drivers, insured's statement, and summary page). In some embodiments, a tree icon 350 may be clicked to open up the navigation panel 317. In some embodiments, the tree icon 350 may be selected to provide a drop down navigation menu. In some embodiments, clicking on an element (e.g., a primary category) in the navigation panel may provide a sub-listing of subparts (e.g., secondary categories) to the element (e.g., selecting vehicles may provide a sub-listing of vehicles). In some embodiments, selecting the primary category or secondary category may display information respective to the category. Other ways of opening component of the policy may also be used (e.g., highlighting a component of the policy).

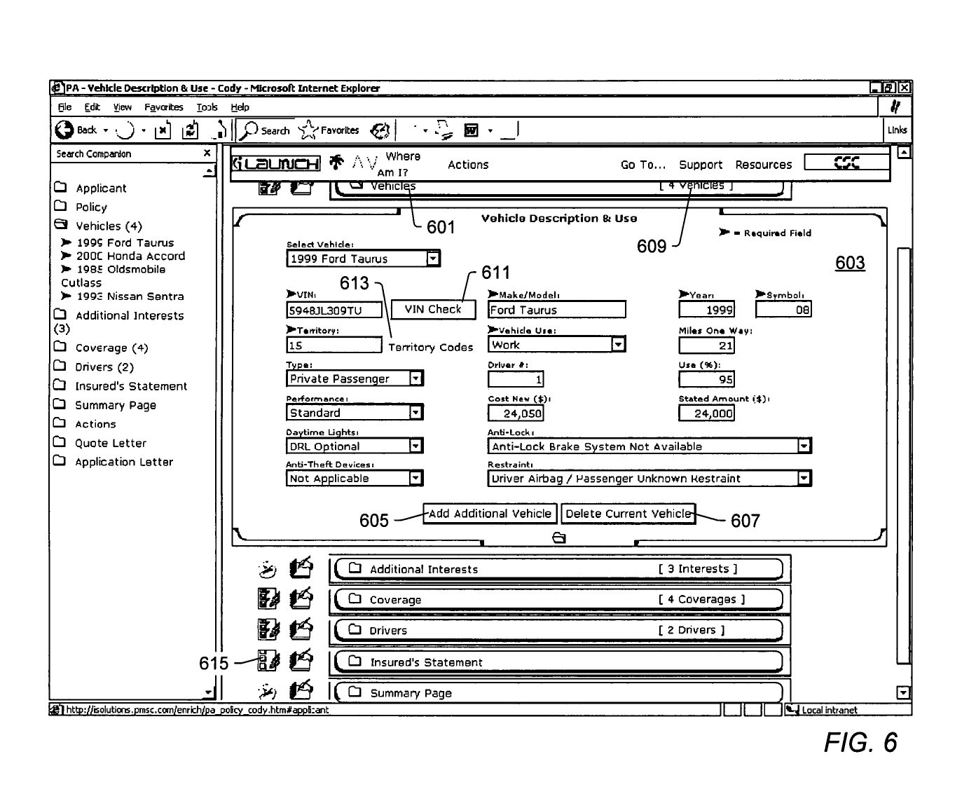

In some embodiments, when a part of an insurance policy is opened, information fields (e.g., name field 315) may be filled in by an insurance agent. In some embodiments, information such as first name, phone number, middle name, last name, location, mailing address, city, state, and postal code may be included. Other entities besides an insurance agent may also have access to the information entered for the insurance policy (e.g., an internal auditor or supervisor). In some embodiments, form icon 309 may be used to indicate whether a component of the policy requires additional data. For example, form icon 309 with checks (as shown) may indicate that a corresponding component of the policy has been completed. In some embodiments, a form icon without checks (e.g., see checked form icon 615 in FIG. 6) may be used to indicate additional information is required. In some embodiments, main page icon 319 may be selected to display a main browser page (discussed more below).

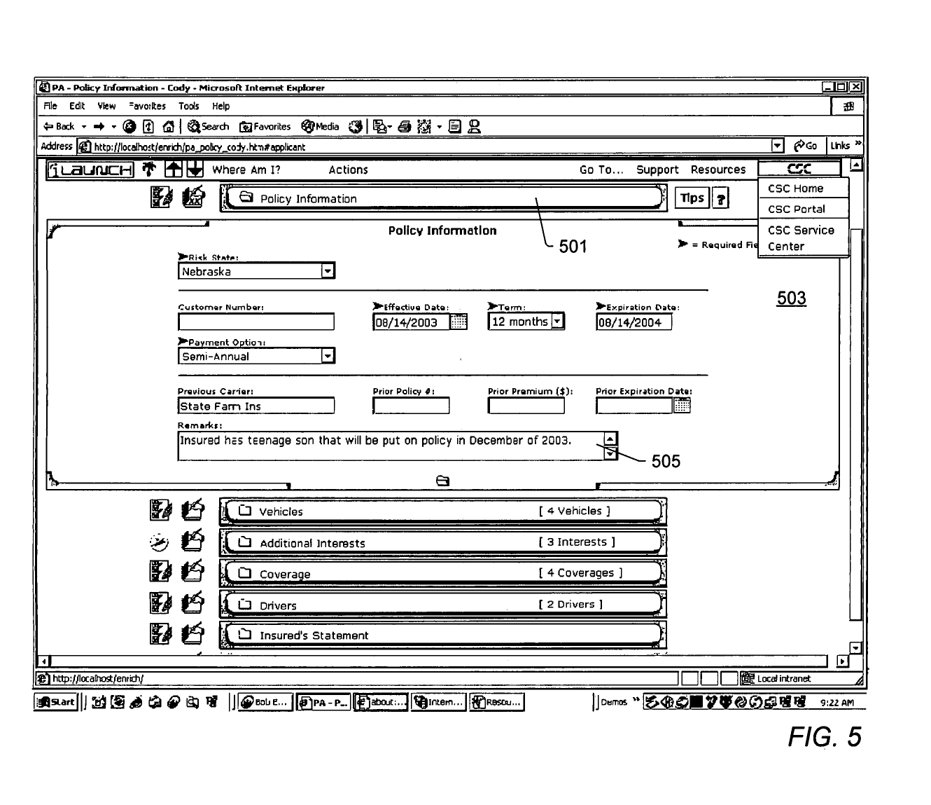

FIG. 5 illustrates an embodiment of policy data entry fields. In some embodiments, policy information panel 503 may be opened by clicking on policy information button 501. In some embodiments, information such as state, customer number, effective date, term, expiration date, payment options, previous carrier, prior policy number, prior premium amount, and prior expiration date may be included. In some embodiments, remark field 505 may be included to give a user another location to enter a note related to the policy.

FIG. 6 illustrates an embodiment of vehicle data entry fields. In some embodiments, vehicle information panel 603 may be opened by clicking on vehicle information button 601. In some embodiments, information such as vehicle identification number (VIN), make/model, year, symbol, territory, vehicle use, miles used, passenger type, number of drivers, performance, new cost, stated cost, and information about available features (e.g., daytime lights, anti-lock brakes, restraints, and anti-theft devices) may be included. In some embodiments, additional vehicles may be added by clicking add additional vehicle button 605. In some embodiments, a vehicle may be removed by clicking delete current vehicle button 607. In some embodiments, information about a component of the policy may be included on the policy part button (e.g., “4 Vehicles” 609 is displayed on vehicle information button 601). In some embodiments, interactive options may be included. For example, VIN check button 611 may be included to allow a user to check information about a vehicle, based on the VIN number, in other databases (e.g., whether the vehicle has been totaled in the past). In another example, territory codes 613 may be clicked to provide a listing (not shown) of possible territory codes and their descriptions.

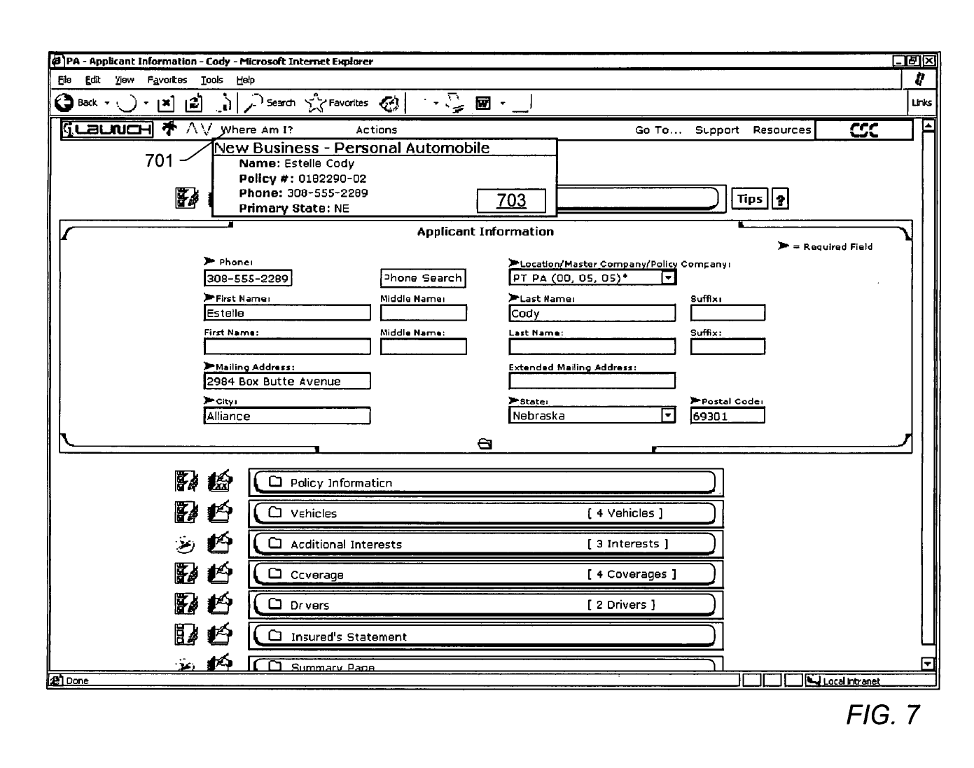

FIG. 7 illustrates an embodiment of a program location panel. In some embodiments, a location identifier (e.g., “Where Am I” 701) may be used to provide a user information about the current policy that is being worked on by the user. For example, in some embodiments, clicking on “Where Am I” 701 may display location panel 701 with information such as type of policy, name, policy number, phone number and primary state. Other information may also be included. In some embodiments, location information may be displayed in a separate panel on the display, may be displayed when a mouse pointer is moved over “Where Am I” 701 button, or may be displayed when a key or key combination is entered. Other ways of requesting location information may also be used.

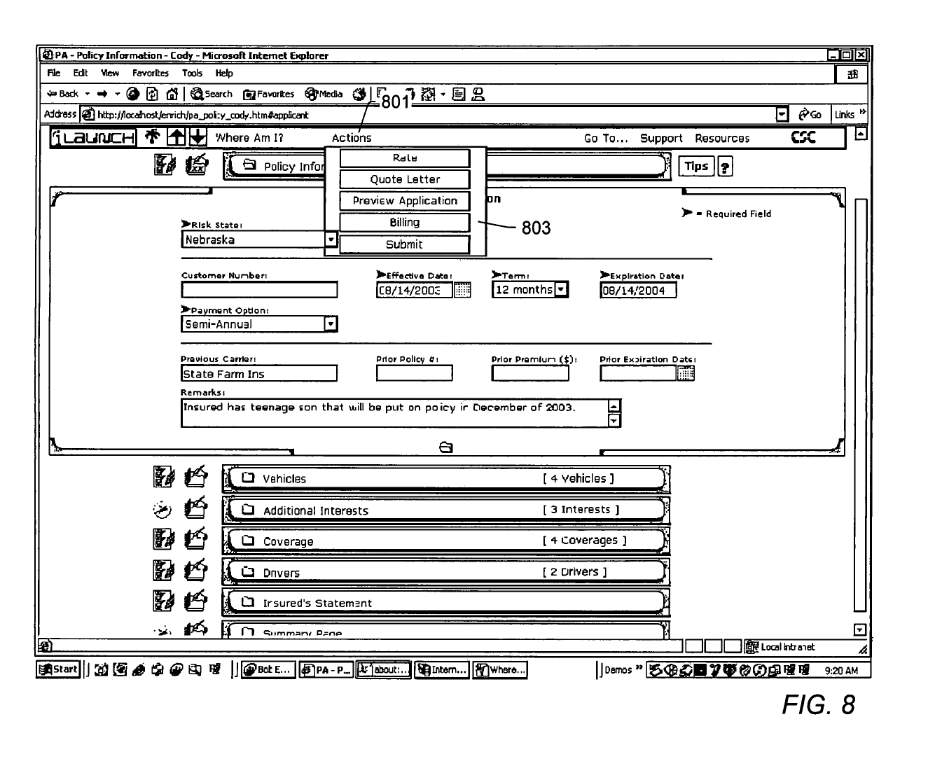

FIG. 8 illustrates another embodiment of available actions panel. In some embodiments, actions panel 803, including a list of available actions to the user, may be displayed. For example, in some embodiments, a user may select actions button 801 to display the available actions panel. In some embodiments, available actions may include rating a policy, preparing a quote letter, previewing an application, billing a policy, and submitting a policy or claim. Other available actions may also be provided. In some embodiments, the available actions panel may be provided as a separate window on the display.

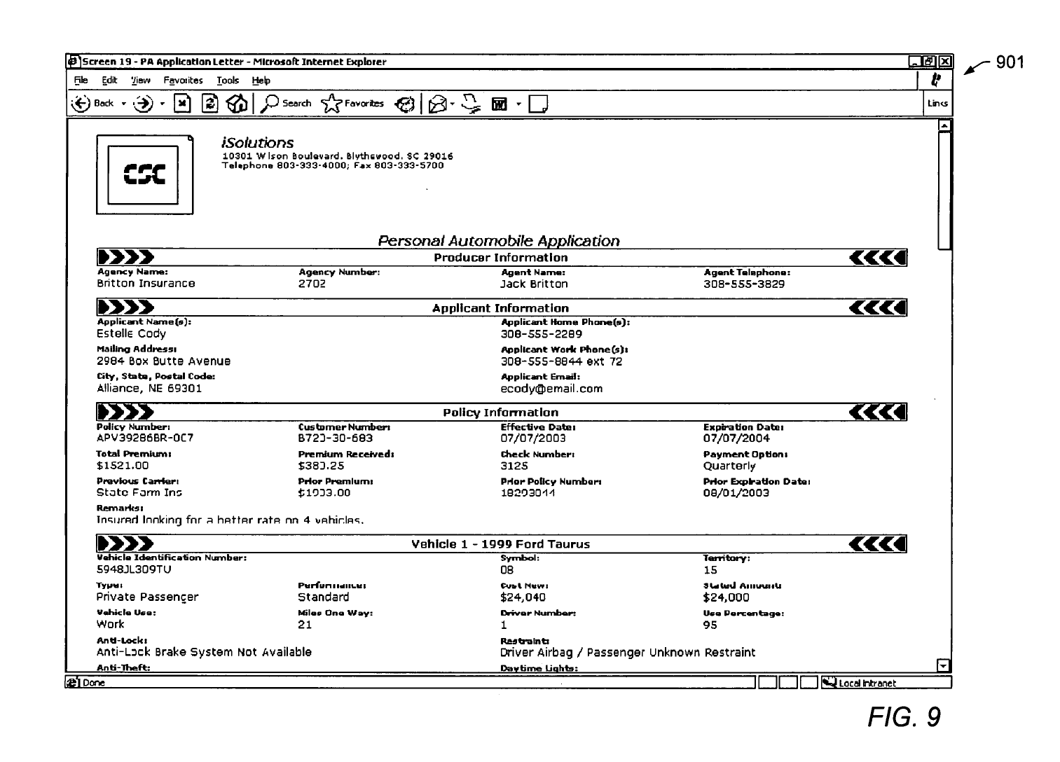

FIG. 9 illustrates an embodiment of policy details. In some embodiments, a user may select an action option to preview an application (e.g., using actions panel 803). In some embodiments, preview panel 901 may provide information about the current policy (e.g., producer information, application information, policy information, and vehicle information). Other information may also be included.

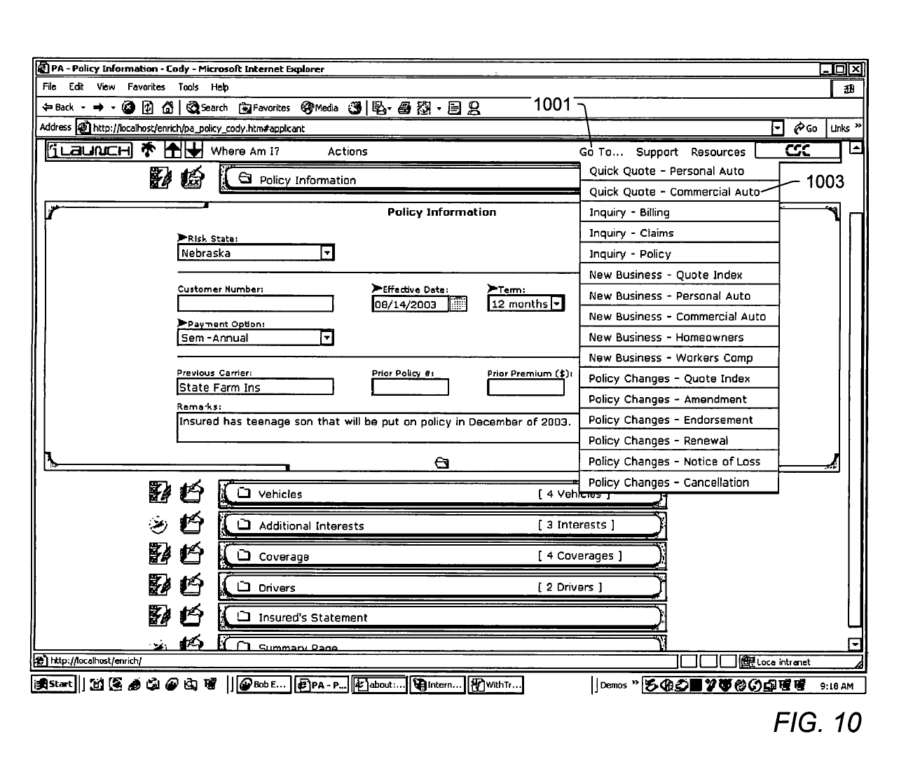

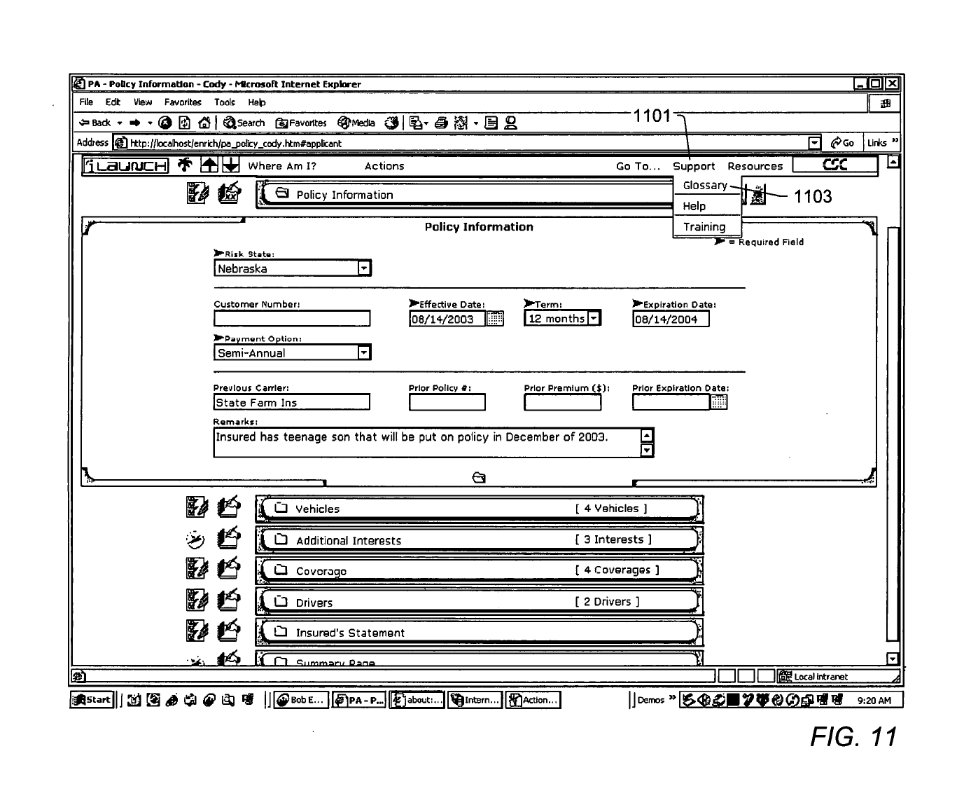

FIG. 10 illustrates an embodiment of a selection drop down menu. In some embodiments, selection menu 1003 may be provided by clicking on a selection icon (e.g., “Go To . . . ” 1001). In some embodiments, the selection menu may include personal auto quick quote, commercial vehicle quick quote, billing inquiry, claim inquiry, policy inquiry, quote index, personal auto, commercial auto, homeowner, worker's comp, quote index, amendment, endorsement, renewal, notice of loss, and cancellation. In some embodiments, the selection menu may be a drop down menu or a separate window of options. Other ways of displaying a selection menu may also be used. FIG. 11 illustrates an embodiment of a support drop down menu. In some embodiments, support drop down menu 1103 may be provided when support indicator 1101 is selected. In some embodiments, the support menu may include a glossary, help, and training.

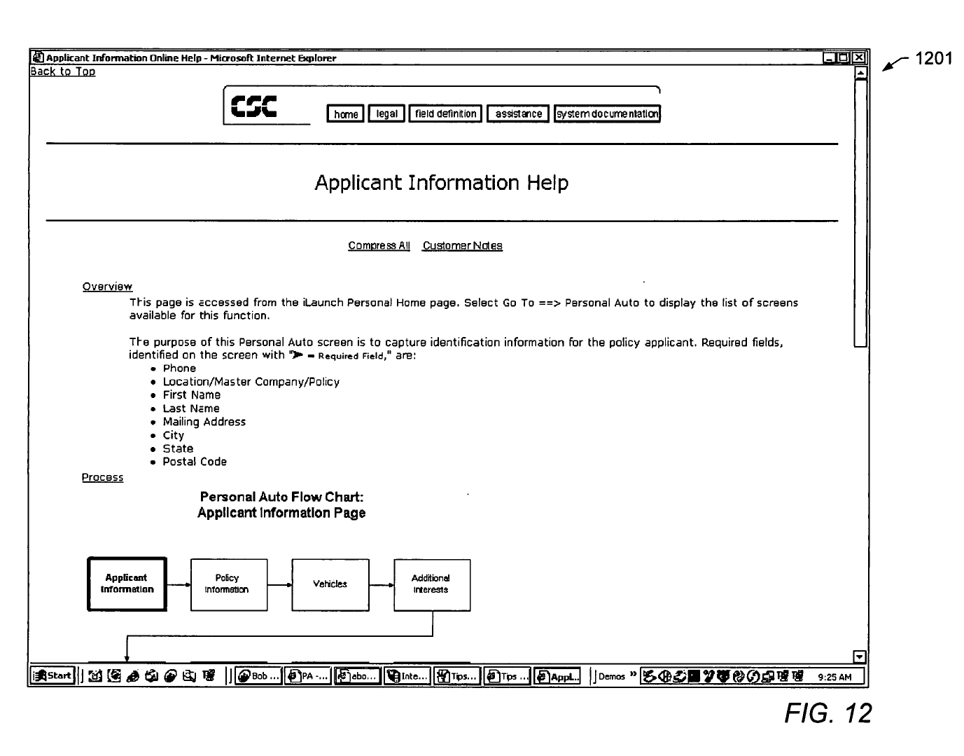

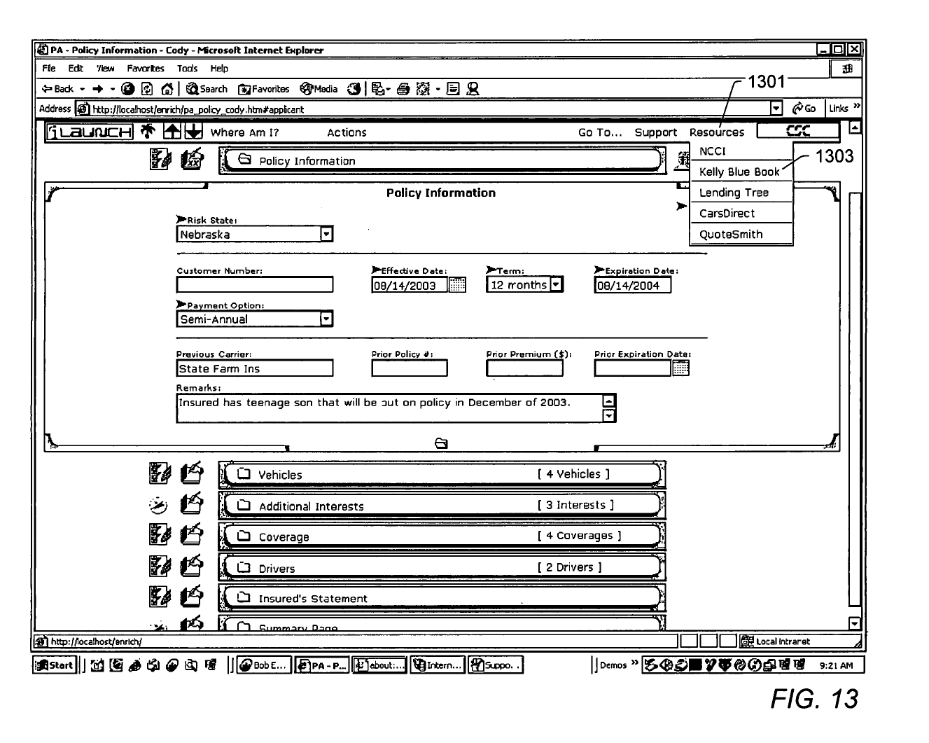

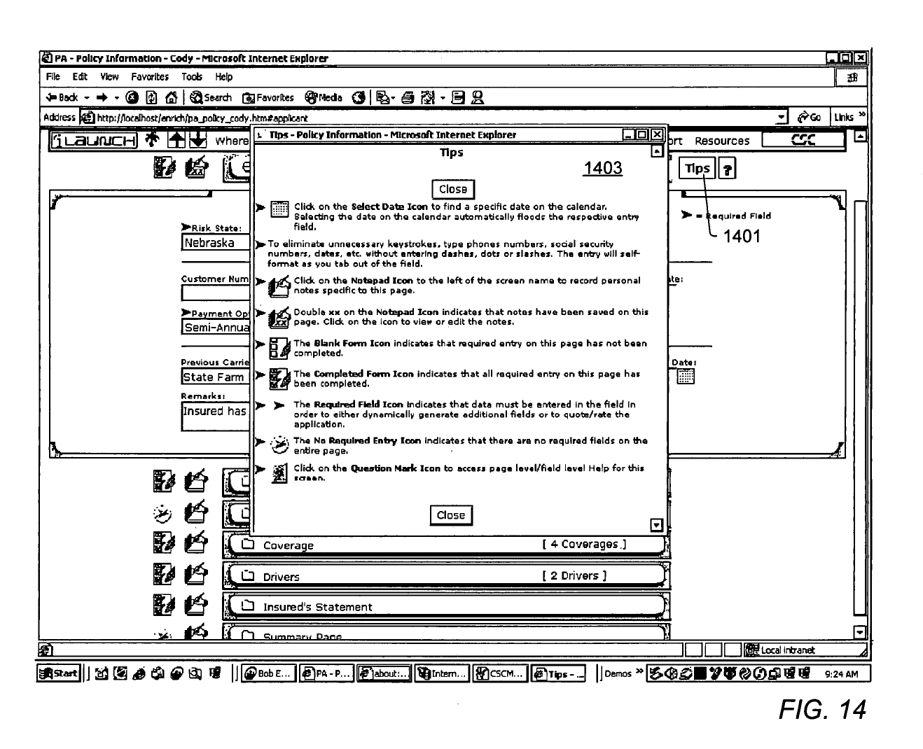

FIG. 12 illustrates an embodiment of an applicant help panel. In some embodiments, if help is selected from the support menu, a help panel 1201 may be displayed. In some embodiments, the help panel 1201 may include information about required information for the policy, paths the user should follow in constructing the policy, and other information helpful to a user. FIG. 13 illustrates an embodiment of a resources drop down menu. In some embodiments, resources drop down menu 1303 may be provided when resource indicator 1301 is selected. In some embodiments, the resources menu may include links to databases and websites that a user may need. FIG. 14 illustrates an embodiment of a tips display panel. In some embodiments, tips icon 1401 may be selected to provide tips panel 1403. In some embodiments, tips panel 1403 may include information about components of the policy, fields in a component of the policy, and icons used. For example, information about the differences between note icons and form icons may be presented.

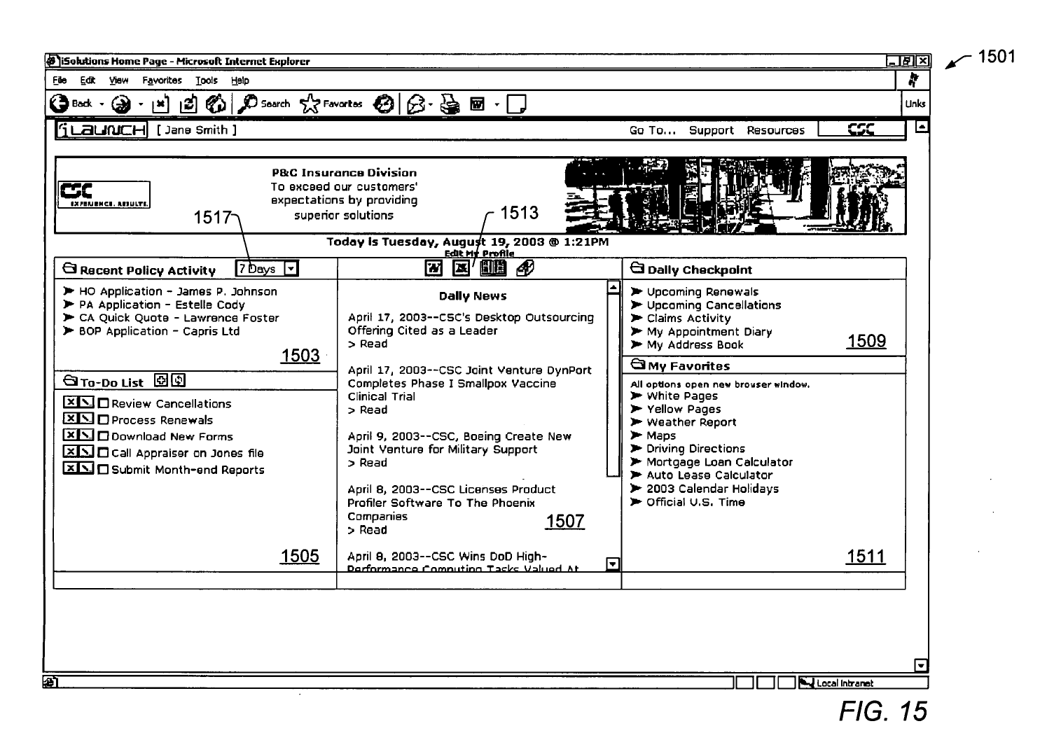

FIG. 15 illustrates an embodiment of a main browser page. In some embodiments, main browser page 1501 may be displayed for a user. In some embodiments, main browser page 1501 may include a listing of recent policy activity 1503, “to-do” list 1505, daily news 1507, daily checkpoint 1509, and favorites 1511. In some embodiments, recent policy activity 1503 may include lists of policies recently worked on, recent calculated quotes, and recent applications. In some embodiments, a number of days 1517 to display recent policy activity for the viewed policy may be selected, inter alia, using a drop down menu or entry field. Other information may also be included in recent policy activity 1503. In some embodiments, “to-do” list 1505 may include reviewing calculations, process renewals, downloading forms, making phone calls, and submitting reports. Other information may also be included on “to-do” list 1505. In some embodiments, “to-do” list items may be added, canceled, checked off, or edited by selecting appropriate buttons next to a “to-do” list item. In some embodiments, items may also be added to the “to-do” list. In some embodiments, daily checkpoints 1509 may include future items (e.g., upcoming renewals, cancellations, and claims activity) or references (e.g., address book and appointment diary). Other information may also be included in daily checkpoints 1509. In some embodiments, favorites 1511 may include links to references (e.g., phone numbers, weather reports, and maps). Other information and lists may also be provided on main browser page 1501. In some embodiments, the information and lists on the main browser page may be configured by a user. In some embodiments, additional information about elements on main browser page 1501 (e.g., recent policy activity 1503 and daily checkpoints 1509) may be provided by selecting a particular element. In some embodiments, a navigation bar of icons for available applications 1513 may be provided (e.g., word applications, spreadsheet applications, a glossary, and electronic mail applications).

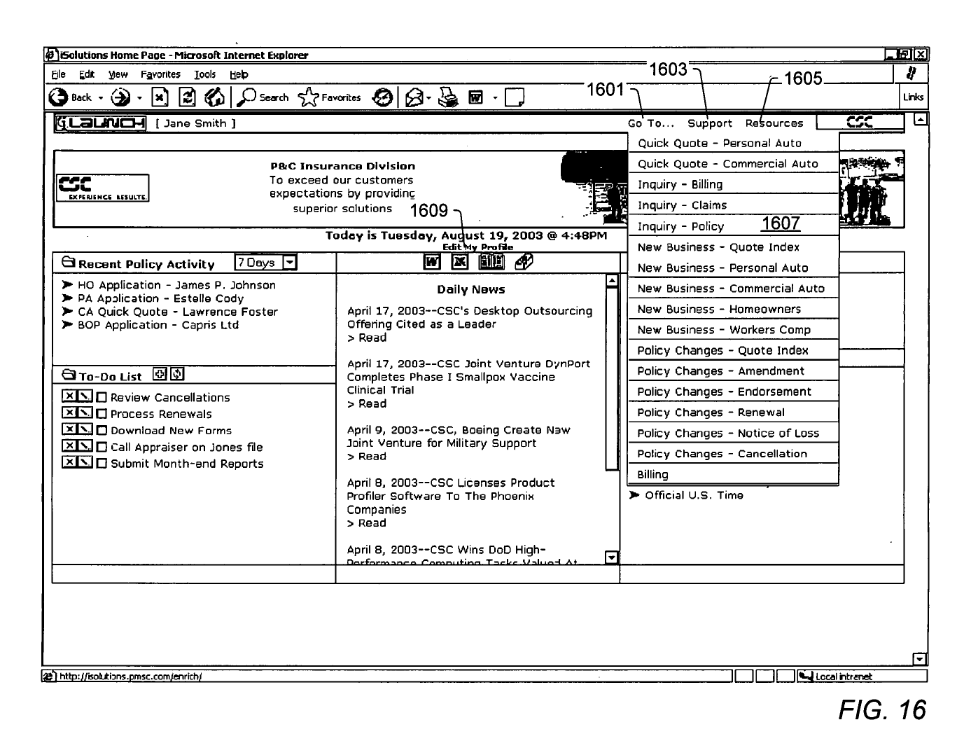

FIG. 16 illustrates an embodiment of a selection drop down menu for a main browser page. In some embodiments, drop down menus for selection drop down menu 1601, support drop down menu 1603, and resources drop down menu 1605 may be provided on the main browser page 1501. In some embodiments, the menus may provide similar options as provided on the insurance information screen 301. In some embodiments, a user's profile may be edited by selecting an appropriate indicator (e.g., “Edit My Profile” 1609).

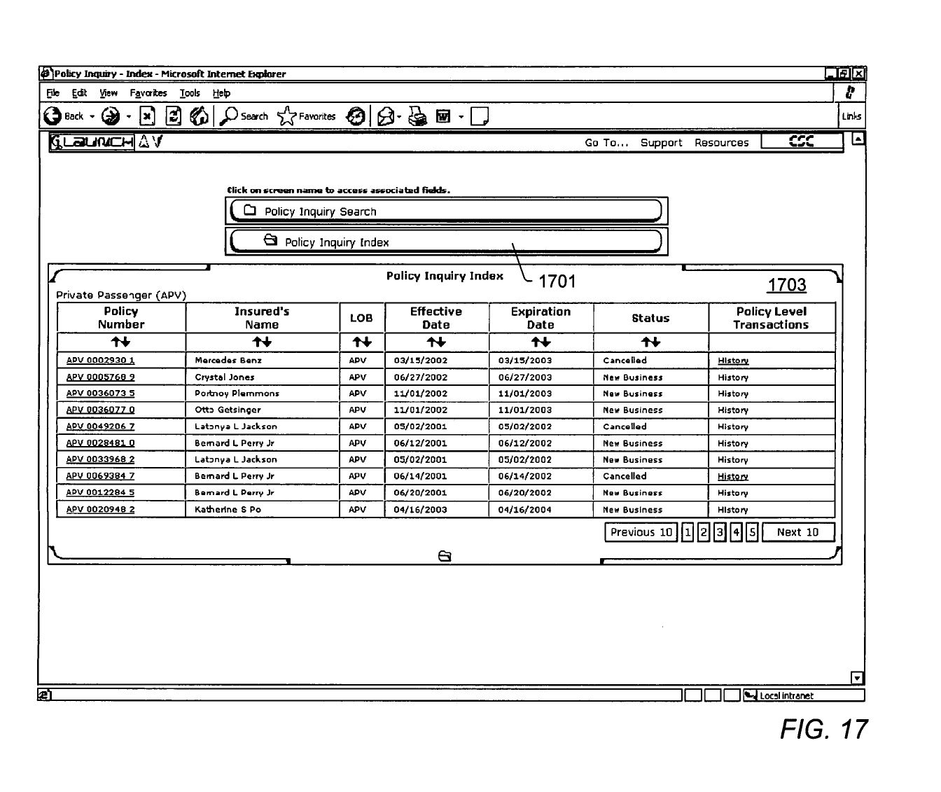

FIG. 17 illustrates an embodiment of a policy inquiry index. In some embodiments, a policy inquiry index screen may be displayed by selecting policy inquiry 1607 from selection drop down menu 1601. Other ways of calling the policy inquiry search may also be used. In some embodiments, the policy inquiry search may provide an index 1703 of available policies for a user to view. In some embodiments, the policies may be listed chronologically. In some embodiments, the policies may be listed in some other order (e.g., alphabetically). In some embodiments, a user may bring up the information for a particular policy by selecting the policy from the index (e.g., by clicking on the policy with the mouse pointer or highlighting the policy).

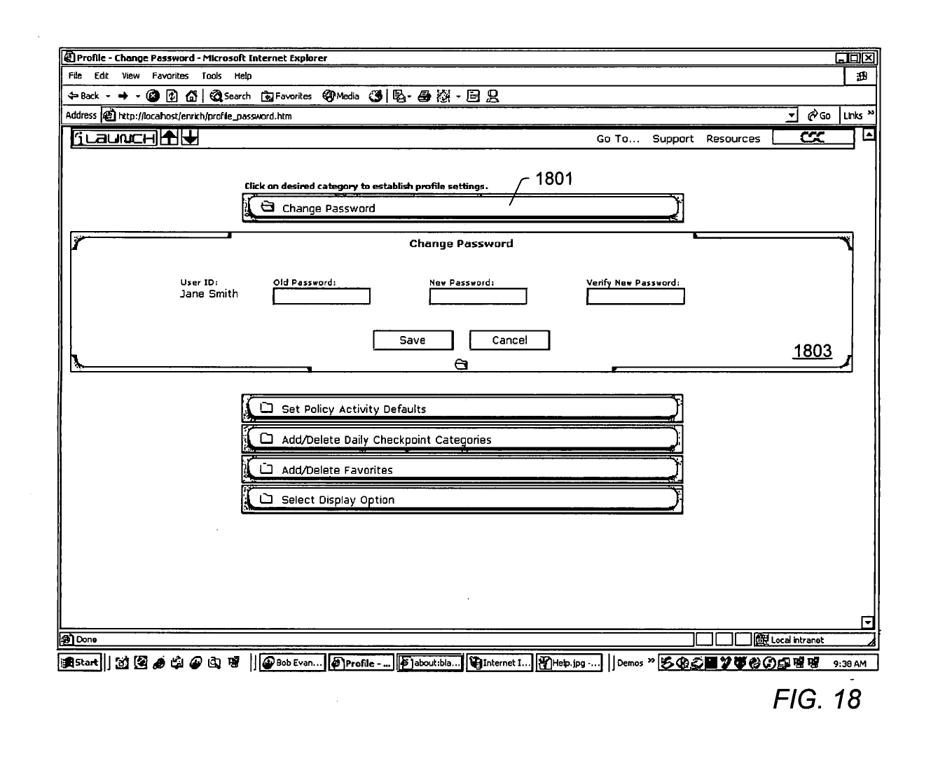

FIG. 18 illustrates an embodiment of a change password screen. In some embodiments, several profile selections (e.g., change password 1801) may be displayed when a user selects “Edit My Profile” 1609 from main browser page 1501. In some embodiments, other ways of displaying the profile selections may also be used. In some embodiments, change password screen 1803 may be provided by selecting change password indicator 1801. In some embodiments, a user's password may be changed by entering an old password, a new password, and verifying the new password.

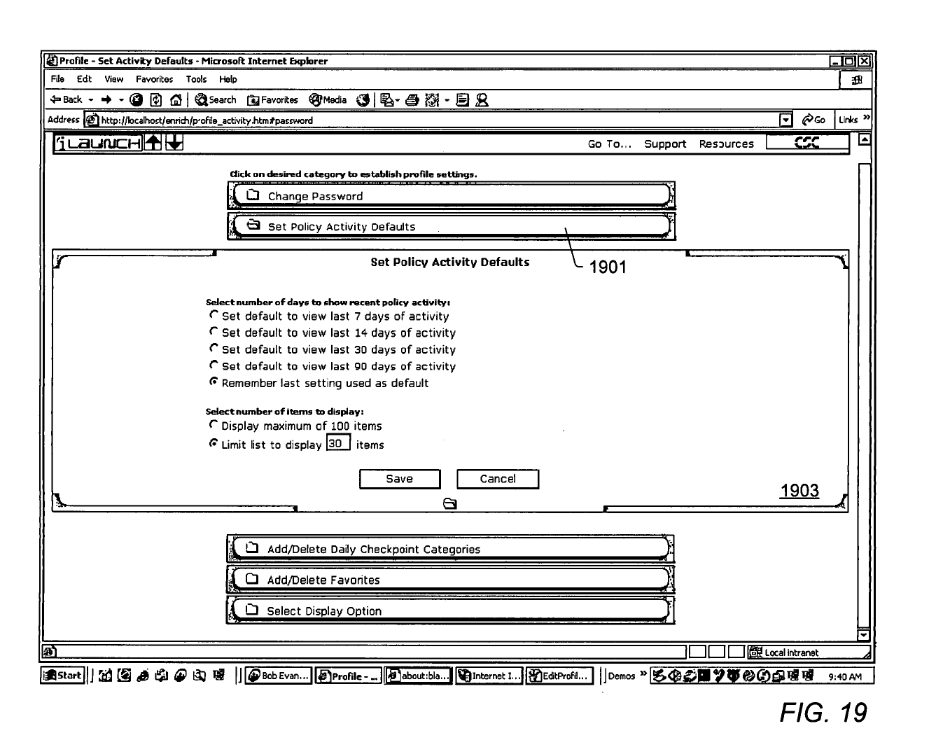

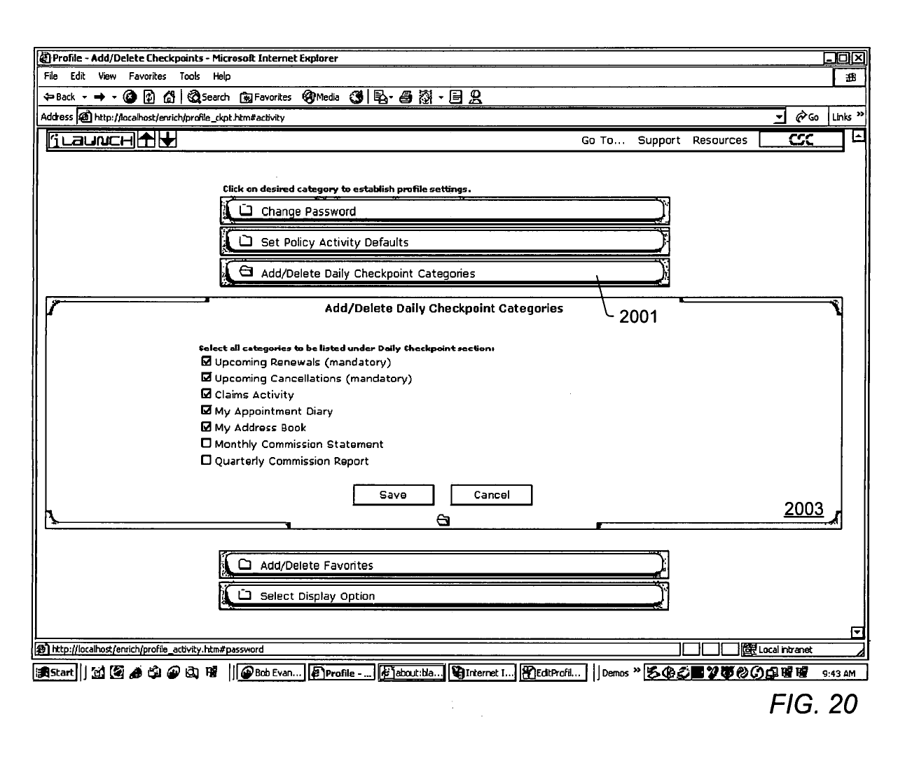

FIG. 19 illustrates an embodiment of policy activity defaults data entry screen. In some embodiments, policy activity defaults may be set using set policy activity defaults panel 1903 displayed when set policy activity defaults indicator 1901 is selected. For example, the number of past days of activity to view on main browser page 1501 may be selected and a number of items to display may be selected. FIG. 20 illustrates an embodiment of a daily checkpoint categories screen. In some embodiments, daily checkpoint categories indicator 2001 may be selected to display a daily checkpoint categories panel 2003. In some embodiments, available daily checkpoint categories may be listed and selected/unselected (e.g., upcoming renewals, upcoming cancellations, claims activity, appointment diary, address book, monthly commission statement, and quarterly commission report).

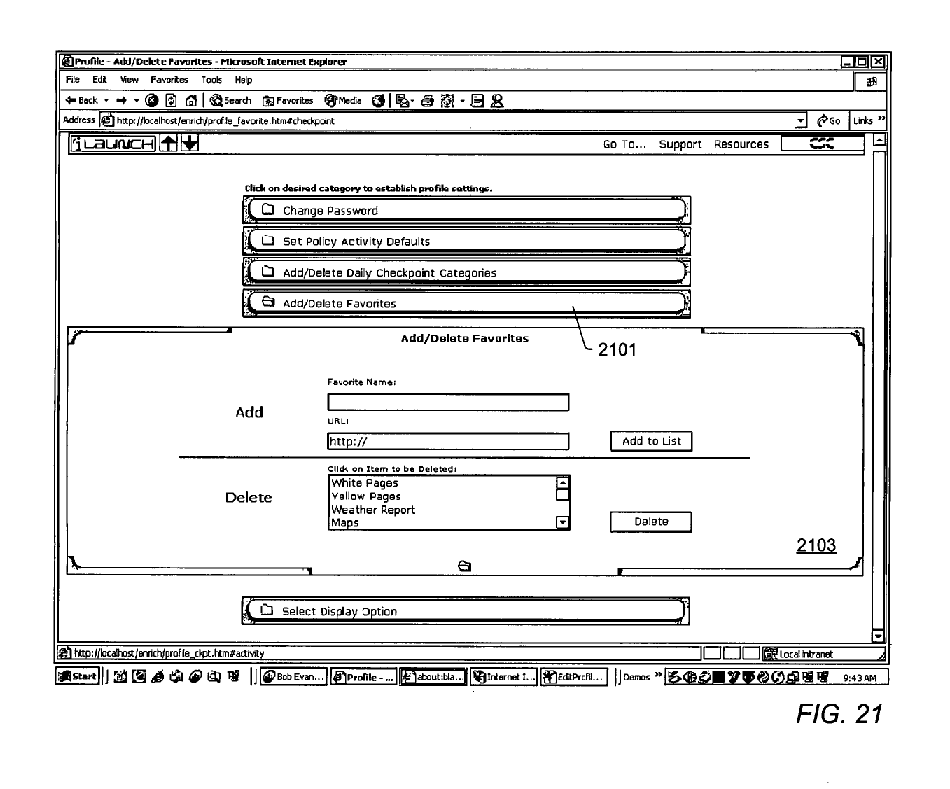

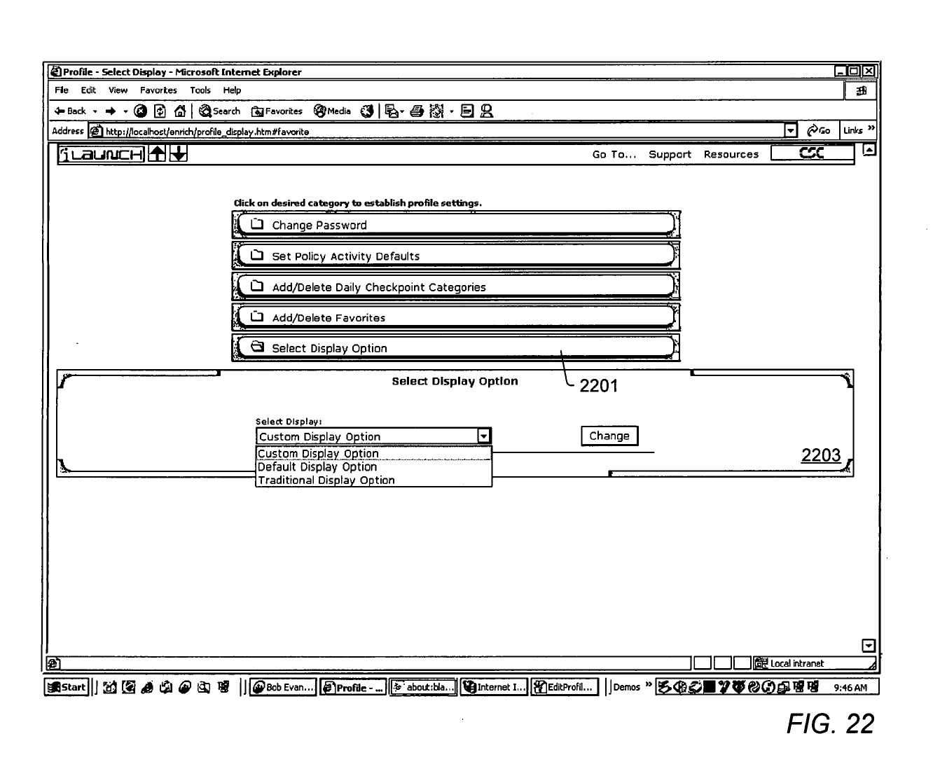

FIG. 21 illustrates an embodiment of a panel for modifying favorites on the main browser page. In some embodiments, favorites may be added or deleted from the listing on main browser page 1501 using favorites selection panel 2103 displayed when favorites indicator 2101 is selected. FIG. 22 illustrates an embodiment of a display selection screen. In some embodiments, display options for main browser page 1501 may be selected on display options panel 2203 by selecting display options indicator 2201. For example, display options may include custom display options, default display options, and traditional display options.

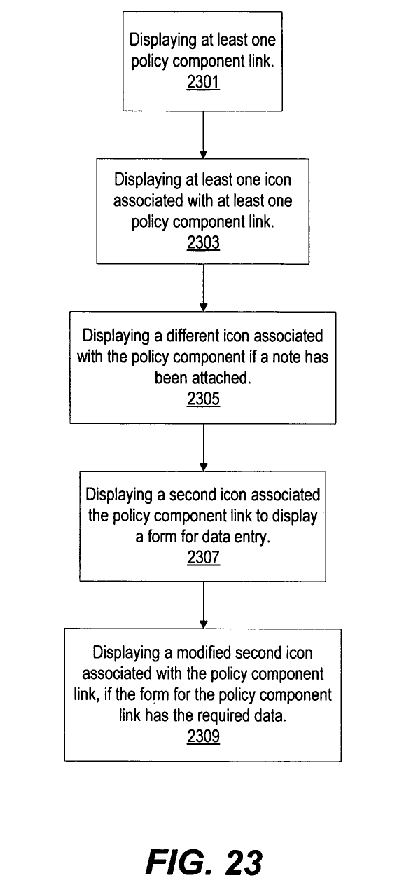

FIG. 23 illustrates a flowchart for configuring and presenting insurance information, according to an embodiment. It should be noted that in various embodiments of the methods described below, one or more of the elements described may be performed concurrently, in a different order than shown, or may be omitted entirely. Other additional elements may also be performed as desired.

At 2301, at least one policy component link may be displayed.

At 2303, at least one icon associated with at least one policy component link may be displayed.

At 2305, a different icon associated with the policy component may be displayed if a note has been attached.

At 2307, a second icon associated the policy component link may be displayed for displaying a form for data entry.

At 2309, a modified second icon associated with the policy component link may be displayed, if the form for the policy component link has the required data.

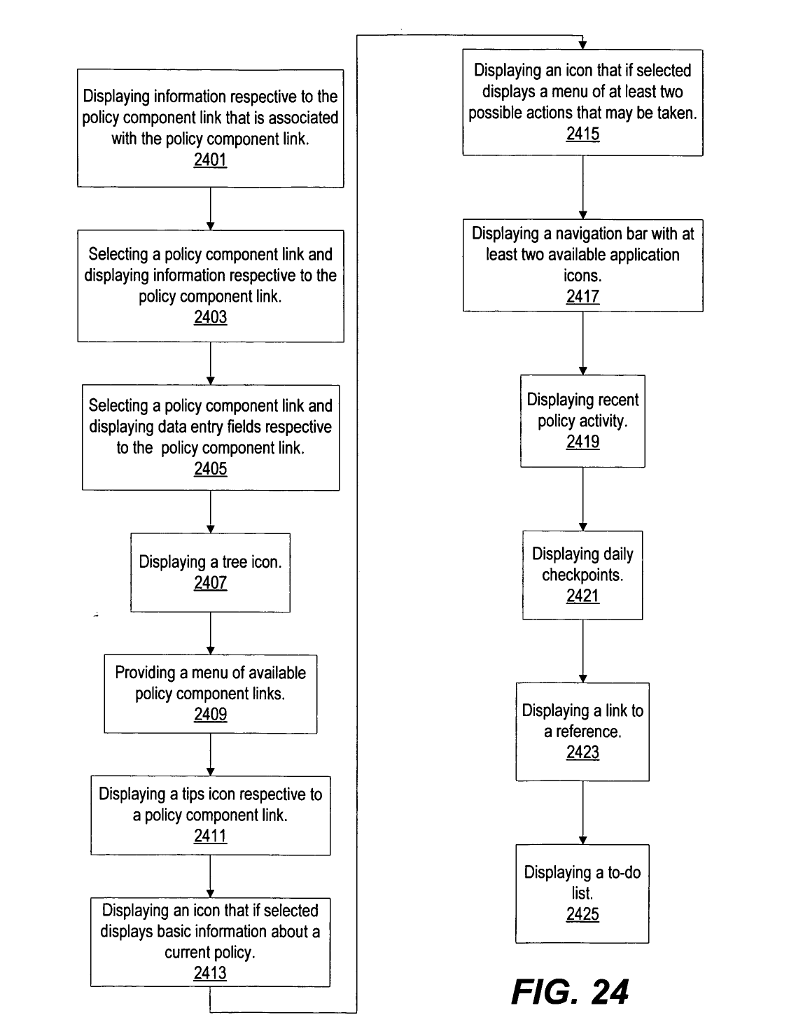

FIG. 24 illustrates a flowchart for displaying information relative to policy component links, according to an embodiment. It should be noted that in various embodiments of the methods described below, one or more of the elements described may be performed concurrently, in a different order than shown, or may be omitted entirely. Other additional elements may also be performed as desired.

At 2401, information may be displayed respective to the policy component link that is associated with the policy component link.

At 2403, a policy component link may be selected and information may be displayed respective to the policy component link.

At 2405, a policy component link may be selected and data entry fields may be displayed respective to the policy component link.

At 2407, a tree icon may be displayed.

At 2409, a menu of available policy component links may be provided.

At 2411, a tips icon may be displayed respective to a policy component link.

At 2413, an icon may be displayed that, if selected, displays basic information about a current policy.

At 2415, an icon may be displayed that, if selected, displays a menu of at least two possible actions that may be taken.

At 2417, a navigation bar may be displayed with at least two available application icons.

At 2419, recent policy activity may be displayed.

At 2421, daily checkpoints may be displayed.

At 2423, a link to a reference may be displayed.

At 2425, a “to-do” list may be displayed.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

What is claimed is:

1. A method of processing a policy on a computer system, comprising:
displaying at least one policy component link; and
displaying at least one icon associated with the at least one policy component link;
wherein selecting the at least one icon allows a user to attach a note respective to the at least one policy component link, and wherein selecting the at least one icon at a later time displays the note entered by the user.

2. The method of claim 1, wherein the policy component is a component of a policy, a policy application, or a claim.

3. The method of claim 1, further comprising displaying a different icon associated with at least one policy component if a note has been attached respective to the at least one policy component link.

4. The method of claim 1, further comprising displaying a second icon associated with the at least one policy component link, wherein selecting the second icon displays a form for data entry respective to this policy component link.

5. The method of claim 1, further comprising displaying a modified second icon associated with the at least one policy component link, if the form for the respective policy component link has the required data.

6. The method of claim 1, wherein at least one icon indicates data is required for the respective policy component link.

7. The method of claim 1, wherein at least one icon indicates data is not required for the respective policy component link.

8. The method of claim 1, wherein at least one icon may be selected to display help related to a policy component link.

9. The method of claim 1, further comprising displaying information respective to at least one policy component link that is associated with the at least one policy component link.

10. The method of claim 1, further comprising selecting at least one policy component link and displaying information respective to the at least one policy component link.

11. The method of claim 1, further comprising selecting at least one policy component link and displaying data entry fields respective to the at least one policy component link.

12. The method of claim 11, wherein the data entry fields are displayed below the selected policy component link and above at least one policy component link displayed below the selected policy component link.

13. The method of claim 1, further comprising displaying a tree icon, wherein selecting the tree icon displays a navigation menu with at least one primary category and at least one secondary category listed with the at least one primary category.

14. The method of claim 13, wherein selecting the at least one primary category or the at least one secondary category displays information respective to the at least one category.

15. The method of claim 13, wherein at least one category is a policy component.

16. The method of claim 1, further comprising providing a menu of available policy component links, wherein selecting a policy component link opens a component of the policy or opens additional menu components to select.

17. The method of claim 1, further comprising displaying a tips icon respective to at least one policy component link, wherein selecting the tips icon displays information to assist a user of the at least one policy component link.

18. The method of claim 17, wherein the information displayed to assist a user includes information about at least one icon.

19. The method of claim 1, further comprising displaying an icon wherein selecting the icon displays basic information about a current policy.

20. The method of claim 1, further comprising displaying an icon wherein selecting the icon displays a menu of at least two possible actions that may be taken.

21. The method of claim 20, wherein possible actions include rating a policy, forming a quote letter, previewing an application, billing, and submitting a claim.

22. The method of claim 1, wherein selecting the at least one icon opens a note window for the user to enter a note.

23. The method of claim 1, wherein selecting the at least one icon opens a file selection window to allow a user to attach a file as a note.

24. The method of claim 1, further comprising displaying a navigation bar with at least two available application icons wherein selecting an available application icon starts the associated application.

25. The method of claim 1, further comprising displaying recent policy activity, including displaying a user selectable number of days of recent policy activity to display.

26. The method of claim 1, further comprising displaying daily checkpoints, wherein the daily checkpoints to display may be user selectable.

27. The method of claim 1, further comprising displaying a link to a reference, wherein the links to display may be user selectable.

28. The method of claim 1, further comprising displaying a to-do list, wherein at least one item on the to-do list is user selectable, and wherein an item on the to-do list may be graphically checked off.

29. A system, comprising:
a computer program;
a computer system; and
wherein the computer program is executable on the computer system to execute a method of:
displaying at least one policy component link; and
displaying at least one icon associated with the at least one policy component link;
wherein selecting the at least one icon allows a user to attach a note respective to the at least one policy component link, and wherein selecting the at least one icon at a later time displays the note entered by the user.

30. The system of claim 29, wherein the policy component is a component of a policy, a policy application, or a claim.

31. The system of claim 29, wherein the method further comprises displaying a different icon associated with at least one policy component if a note has been attached respective to the at least one policy component link.

32. The system of claim 29, wherein the method further comprises displaying a second icon associated with the at least one policy component link, wherein selecting the second icon displays a form for data entry respective to this policy component link.

33. The system of claim 29, wherein the method further comprises displaying a modified second icon associated with the at least one policy component link, if the form for the respective policy component link has the required data.

34. The system of claim 29, wherein at least one icon indicates data is required for the respective policy component link.

35. The system of claim 29, wherein at least one icon indicates data is not required for the respective policy component link.

36. The system of claim 29, wherein at least one icon may be selected to display help related to a policy component link.

37. The system of claim 29, wherein the method further comprises displaying information respective to at least one policy component link that is associated with the at least one policy component link.

38. The system of claim 29, wherein the method further comprises selecting at least one policy component link and displaying information respective to the at least one policy component link.

39. The system of claim 29, wherein the method further comprises selecting at least one policy component link and displaying data entry fields respective to the at least one policy component link.

40. The system of claim 39, wherein the data entry fields are displayed below the selected policy component link and above at least one policy component link displayed below the selected policy component link.

41. The system of claim 29, wherein the method further comprises displaying a tree icon, wherein selecting the tree icon displays a navigation menu with at least one primary category and at least one secondary category listed with the at least one primary category.

42. The system of claim 41, wherein selecting the at least one primary category or the at least one secondary category displays information respective to the at least one category.

43. The system of claim 41, wherein at least one category is a policy component.

44. The system of claim 29, wherein the method further comprises providing a menu of available policy component links, wherein selecting a policy component link opens a component of the policy or opens additional menu components to select.

45. The system of claim 29, wherein the method further comprises displaying a tips icon respective to at least one policy component link, wherein selecting the tips icon displays information to assist a user of the at least one policy component link.

46. The system of claim 45, wherein the information displayed to assist a user includes information about at least one icon.

47. The system of claim 29, wherein the method further comprises displaying an icon wherein selecting the icon displays basic information about a current policy.

48. The system of claim 29, wherein the method further comprises displaying an icon wherein selecting the icon displays a menu of at least two possible actions that may be taken.

49. The system of claim 48, wherein possible actions include rating a policy, forming a quote letter, previewing an application, billing, and submitting a claim.

50. The system of claim 29, wherein selecting the at least one icon opens a note window for the user to enter a note.

51. The system of claim 29, wherein selecting the at least one icon opens a file selection window to allow a user to attach a file as a note.

52. The system of claim 29, wherein the method further comprises displaying a navigation bar with at least two available application icons wherein selecting an available application icon starts the associated application.

53. The system of claim 29, wherein the method further comprises displaying recent policy activity, including displaying a user selectable number of days of recent policy activity to display.

54. The system of claim 29, wherein the method further comprises displaying daily checkpoints, wherein the daily checkpoints to display may be user selectable.

55. The system of claim 29, wherein the method further comprises displaying a link to a reference, wherein the links to display may be user selectable.

56. The system of claim 29, wherein the method further comprises displaying a to-do list, wherein at least one item on the to-do list is user selectable, and wherein an item on the to-do list may be graphically checked off.

57. A carrier medium comprising program instructions, wherein the program instructions are executable by a computer system to implement a method of:
displaying at least one policy component link; and
displaying at least one icon associated with the at least one policy component link;
wherein selecting the at least one icon allows a user to attach a note respective to the at least one policy component link, and wherein selecting the at least one icon at a later time displays the note entered by the user.

58. The carrier medium of claim 57, wherein the policy component is a component of a policy, a policy application, or a claim.

59. The carrier medium of claim 57, wherein the method further comprises displaying a different icon associated with at least one policy component if a note has been attached respective to the at least one policy component link.

60. The carrier medium of claim 57, wherein the method further comprises displaying a second icon associated with the at least one policy component link, wherein selecting the second icon displays a form for data entry respective to this policy component link.

61. The carrier medium of claim 57, wherein the method further comprises displaying a modified second icon associated with the at least one policy component link, if the form for the respective policy component link has the required data.

62. The carrier medium of claim 57, wherein at least one icon indicates data is required for the respective policy component link.

63. The carrier medium of claim 57, wherein at least one icon indicates data is not required for the respective policy component link.

64. The carrier medium of claim 57, wherein at least one icon may be selected to display help related to a policy component link.

65. The carrier medium of claim 57, wherein the method further comprises displaying information respective to at least one policy component link that is associated with the at least one policy component link.

66. The carrier medium of claim 57, wherein the method further comprises selecting at least one policy component link and displaying information respective to the at least one policy component link.

67. The carrier medium of claim 57, wherein the method further comprises selecting at least one policy component link and displaying data entry fields respective to the at least one policy component link.

68. The carrier medium of claim 67, wherein the data entry fields are displayed below the selected policy component link and above at least one policy component link displayed below the selected policy component link.

69. The carrier medium of claim 57, wherein the method further comprises displaying a tree icon, wherein selecting the tree icon displays a navigation menu with at least one primary category and at least one secondary category listed with the at least one primary category.

70. The carrier medium of claim 69, wherein selecting the at least one primary category or the at least one secondary category displays information respective to the at least one category.

71. The carrier medium of claim 69, wherein at least one category is a policy component.

72. The carrier medium of claim 57, wherein the method further comprises providing a menu of available policy component links, wherein selecting a policy component link opens a component of the policy or opens additional menu components to select.

73. The carrier medium of claim 57, wherein the method further comprises displaying a tips icon respective to at least one policy component link, wherein selecting the tips icon displays information to assist a user of the at least one policy component link.

74. The carrier medium of claim 73, wherein the information displayed to assist a user includes information about at least one icon.

75. The carrier medium of claim 57, wherein the method further comprises displaying an icon wherein selecting the icon displays basic information about a current policy.

76. The carrier medium of claim 57, wherein the method further comprises displaying an icon wherein selecting the icon displays a menu of at least two possible actions that may be taken.

77. The carrier medium of claim 76, wherein possible actions include rating a policy, forming a quote letter, previewing an application, billing, and submitting a claim.

78. The carrier medium of claim 57, wherein selecting the at least one icon opens a note window for the user to enter a note.

79. The carrier medium of claim 57, wherein selecting the at least one icon opens a file selection window to allow a user to attach a file as a note.

80. The carrier medium of claim 57, wherein the method further comprises displaying a navigation bar with at least two available application icons wherein selecting an available application icon starts the associated application.

81. The carrier medium of claim 57, wherein the method further comprises displaying recent policy activity, including displaying a user selectable number of days of recent policy activity to display.

82. The carrier medium of claim 57, wherein the method further comprises displaying daily checkpoints, wherein the daily checkpoints to display may be user selectable.

83. The carrier medium of claim 57, wherein the method further comprises displaying a link to a reference, wherein the links to display may be user selectable.

84. The carrier medium of claim 57, wherein the method further comprises displaying a to-do list, wherein at least one item on the to-do list is user selectable, and wherein an item on the to-do list may be graphically checked off.
